(19) United States
(12) Patent Application Publication
(10) Pub. No.: US 2011/0163045 A1
(43) Pub. Date: Jul. 7, 2011

(54) METHOD AND SYSTEM FOR TREATING CONTAMINATED WATER

(75) Inventors: Hadas Mamane, Caesarea (IL); Dror Avisar, Zoran (IL); Yaal Lester, Ein Harod Ichud (IL); Igal Gozlan, Haifa (IL)

(73) Assignee: Ramot at Tel-Aviv University Ltd., Tel-Aviv (IL)

(21) Appl. No.: 13/062,518

(22) PCT Filed: Sep. 7, 2009
(86) PCT No.: PCT/IL09/00869

§ 371 Date: Mar. 7, 2011

(30) Foreign Application Priority Data
Sep. 7, 2008 (IL) 193935

(51) Int. Cl. C02F 1/32; C02F 1/00; G01N 31/00; G06F 17/30

(52) U.S. Cl. 210/748.1; 210/748.01; 422/62; 707/792; 707/E17.005

(57) ABSTRACT

Methods and systems for treatment, remediation, and purification of contaminated water at an optimal pH for are provided herein, as well as a database for use in said methods and systems. The methods and systems are based on identifying one or more contaminants in the contaminated water, and identifying an optimal pH for performing direct photodegradation of the contaminant(s).

### FIELD OF THE INVENTION

The present invention, in some embodiments thereof, relates to the field of water treatment, remediation, and purification, and more particularly, but not exclusively, to photodegradation and the use of photolytic techniques for treating, remediating, and purifying contaminated water.

### BACKGROUND OF THE INVENTION

Contaminated water contains any number or combination of a wide variety of different types or kinds of organic chemical contaminants, many of which can be photolytically degraded by e.g., irradiation. Important examples of such water contaminants are the widely known and used biologically active (bioactive) organic compounds such as pharmaceuticals (e.g., drugs), agrochemicals (e.g., pesticides) and other less known special bioactive organic compounds (such as microcystins [cyclic heptapeptide hepatotoxins produced by cyanobacterial genera]).

Many contaminants (such as bioactive organic compounds), at sufficiently high concentration, are toxic or potentially toxic inside of living organisms (humans, animals, plants). Governmental environmental and health regulatory agencies in most countries throughout the world typically have standard requirements limiting the levels of many types of contaminants in primary water sources (such as ground water, surface water, and above-surface water, types of reservoirs) which supply water for drinking, bathing, agricultural, and other direct or indirect uses by living organisms, as well as in secondary water sources (such as industrial or commercial, governmental, and residential, types of wastewater) which actively or potentially, directly or indirectly, come into contact with primary water sources. For many types of contaminants, such limiting levels are as low as on the order of 1 milligram per liter (mg/l) [1 part per million (ppm)], and may even be as low as on the order of less than 1 microgram per liter (μg/l) [1 part per billion (ppb)]. Accordingly, any such primary or secondary water source should have a total concentration of contaminants within the limiting levels established by governmental environmental and health regulatory agencies. As a result, such primary and secondary water sources are often monitored for contaminants, and if necessary, subjected to treatment or purification for removing, or at least degrading, the contaminants, so that the treated or purified water contains contaminants within acceptable established levels, before such water is directly or indirectly used by living organisms.

Potential sources of pharmaceutical and pesticide water contamination include chemical manufacture facilities, medical facilities, and those who receive them and use them (e.g., humans, animals, plants). Nevertheless, most of these chemicals are not regulated in any way and their potential health effects and acute toxicities in the environment are not well known [1]. For example, some of the major concerns of antibiotic residues (a main subset product of the pharmaceutical industry) in the environment involve the development of multiple drug resistant bacteria that will flourish and make its way into the food chain and may even severely affect human health.

Ultimately, a portion of the waste generated from these sources will reach waste water treatment plants (WWTPs). Several studies conducted throughout Europe and the USA have confirmed the occurrence of pharmaceutical residues (e.g., antiphlogistic, blood lipid regulators, anti-inflammatory drugs, and antibiotics), and pesticides, in surface and groundwater [2, 3, 4]. For example, frequently used pharmaceuticals (the anti-epileptic carbamazepine), analgesic anti-inflammatory drugs (ibuprofen, diclofenac, ketoprofen, and naproxen), and pesticides (triazines, acetamides, and phenoxy acid), were detected in lakes, rivers and WWTP effluents in Switzerland at concentrations ranging between 5-3500 nanograms per liter (ng/l) [parts per trillion (pptr)] [5]. More than 20 individual pharmaceuticals belonging to different therapeutic classes were found in WWTP effluents in four European countries (Italy, France, Greece, and Sweden) [6]. The occurrence and fate of 22 compounds including pharmaceuticals, personal care products, and endocrine disrupting compounds (PPCPs and EDCs), were investigated [7] at various locations within the water use cycle in the city of Ann Arbor, Mich., USA. Laboratory analysis indicated that over the four sampling cites, 17 compounds were detected in wastewater influent, 15 compounds were detected in treated wastewater effluent, 10 compounds were detected in source water (Huron River), and 4 compounds were detected in drinking water.

While current water treatment technologies produce water that may satisfy current regulatory standards, the list of water contaminants (for example, bioactive organic compounds such as pharmaceuticals and pesticides) that are not regulated in drinking water is extensive, thus, low concentrations of such water contaminants are being legally discharged from point and non-point sources to receiving waters [8]. As a result, some of those water contaminants will be discharged to receiving bodies of water or used for irrigation and may result in contamination of ground water.

A study [9] was made for determining the effectiveness of conventional water treatment processes, specifically, coagulation, lime softening, powdered activated carbon (PAC) sorption, chlorination, ozonation, ion exchange, monochromatic ultraviolet photodegradation, and reverse osmosis processes, for the removal of several common antibiotic drugs. Results of the study showed that sorption on powdered activated carbon, reverse osmosis, and oxidation with chlorine and ozone, under typical water treatment plant conditions, were all relatively effective in removing the studied antibiotics. However, water treatment methods of coagulation/flocculation/sedimentation with alum and iron salts, excess lime/soda ash softening, ultraviolet irradiation at disinfection dosages, and ion exchange, were all ineffective for removing the antibiotics.

There are two separate types of photolysis—‘direct’ photolysis and ‘indirect’ photolysis, where each type of photolysis is applicable for treating, remediating, and purifying contaminated water.

According to the fundamental process and mechanism of direct photolysis, electromagnetic radiation, in the form of photons, propagates from a source (e.g., a [IR, VIS, or UV] light lamp) and directly impinges upon a (primary or final) target atom or group of atoms [of a molecule or compound], whereby the (primary or final) target atom or group of atoms absorbs the impinging photons and becomes transformed (modified, degraded) to another species. In indirect photolysis, electromagnetic radiation, in the form of photons, propagates from a source (e.g., a [IR, VIS, or UV] light lamp) and impinges upon a (secondary, initial, initiator, or precursor) target atom or group of atoms [of a molecule or compound], whereby the (secondary, initial, initiator, or precursor) target atom or group of atoms absorbs the impinging photons and becomes transformed (modified, degraded) to another species, followed by physicochemical interaction of that other species with a (primary or final) target atom or group of atoms, whereby the (primary or final) target atom or group of atoms becomes transformed (modified, degraded) to another species.

In the general and widely encompassing field of water treatment, remediation, and purification, there are practiced processes categorically referred to as Advanced Oxidation Processes' (AOP or AOPs). AOPs do not require, or necessarily involve, the use of irradiation.

‘Advanced oxidation process(es) (AOPs)’ can be generally defined and described as follows [13] (and also described in [14-16]):

“Advanced Oxidation Processes (abbreviation: AOP), refers to a set of chemical treatment procedures designed to remove organic and inorganic materials in waste water by oxidation.

Contaminants are oxidized by four different reagents: ozone, hydrogen peroxide, oxygen, and air, in precise, pre-programmed dosages, sequences, and combinations. These procedures may also be combined with UV irradiation and specific catalysts. This results in the development of hydroxyl radicals. A well known example of AOP is the use of Fenton's reagent.

The AOP procedure is particularly useful for cleaning biologically toxic or non-degradable materials such as aromatics, pesticides, petroleum constituents, and volatile organic compounds in waste water. The contaminant materials are converted to a large extent into stable inorganic compounds such as water, carbon dioxide and salts, i.e. they undergo mineralization. A goal of the waste water purification by means of AOP procedures is the reduction of the chemical contaminants and the toxicity to such an extent that the cleaned waste water may be reintroduced into receiving streams or, at least, into a conventional sewage treatment”.

Selected additional teachings of ‘indirect’ photolysis, advanced oxidation processes (AOPs), and techniques thereof, for treating, remediating, or purifying, contaminated water, for various different types of water contaminants, are provided herein [e.g., 17-30].

More recently, an investigation [31] was made regarding the potential of advanced oxidation processes (AOP's), via indirect photolysis, on the removal of eight selected pesticides (being exemplary agrochemical type of bioactive organic compound water contaminants) listed on the U.S. EPA Contaminant Candidate List (CCL), by the combined UV/H₂O₂ process that forms the reactive hydroxyl radicals. All pesticides were found to be very reactive toward hydroxyl radicals as indicated by rate constant values above 10⁹ M⁻¹ s⁻¹, thus, UV/H₂O₂ can be a potentially valid technology for the removal of the examined pesticides. In a different study [32], the same investigators studied the ‘indirect’ photolysis of 3,5,6-trichloro-2-pyridinol (TCP), a hydrolysis degradation product of the insecticide chlorpyrifos (an exemplary agrochemical [pesticide] type of bioactive organic compound water contaminant). It was found that addition of only 5 mg/L hydrogen peroxide via the indirect photolytic process at UV fluence of 50 mJ/cm² resulted in an increase in the degradation rate of TCP to 50%, compared to approximately 40% via the direct photolytic process.

Although not involving the use of photolysis, or photolytic techniques, regarding treatment of wastewater for degrading pharmaceuticals [drugs] (being exemplary bioactive organic compound water contaminants), an investigation [33] was made into the treatment of hospital and pharmaceutical wastewaters in several WWTPs in Germany. The results showed that many pharmaceuticals could not be biodegraded during conventional biological treatment, nor could they be adsorbed by sewage sludge.

Selected teachings of direct photolysis and the use of direct photolytic techniques for treating, remediating, and purifying contaminated water, are presented herein as follows.

Ultraviolet (UV) treatment of water (a type of direct photolysis) is being increasingly used for disinfection of wastewater and drinking water in North America, Europe, and numerous other countries around the world [34]. For most chemicals, direct UV photolysis alone is not sufficient to induce degradation. However, numerous chemical contaminants of concern absorb UV at wavelengths below 300 nm, hence can potentially undergo direct photolysis [32].

Direct photolysis for removal of contaminants was shown to be effective only when the absorption spectrum of the water contaminant overlaps the emission spectrum of the UV lamp and the quantum yield (QY) of the photochemical process is reasonably large. An investigation [35] was made on the photodegradation of a widely used herbicide, metolachlor (being an exemplary agrochemical [pesticide] type of bioactive organic compound water contaminant), by applying monochromatic (254 nm) UV light. Approximately half of the metolachlor was degraded at UV fluence of 1000 mJ/cm² (at pH 7.5), which is 30 times higher than the typical UV dose at water treatment plants (WTPs).

References [15], [17], [18], [19], [28], [29], [30] describe AOP types of indirect photolytic technique with apparent pH effects.

Reference [32] includes the apparent teaching that UV direct photolysis and photodegradation rate of 3,5,6-trichloro-2-pyridinol (TCP) increased with solution pH up to a constant maximum value of 6.40×10⁻³ cm² mJ⁻¹ at pH 5, and, thus, was highly pH dependant within the pH range of 2.5 to 5.

Reference [31] includes the apparent teaching that for direct UV photolysis of the pharmaceutical metronidazole (being an exemplary bioactive organic compound water contaminant), there was low removal efficiency of direct photolysis at pH 6 and no significant dependency on the aqueous solution pH for the direct UV photolysis of pH 3-9.5, as there was no change in the ionic charge (above its pKa of 2.4).

### SUMMARY OF THE INVENTION

The present invention, in some embodiments thereof, relates to the field of water treatment, remediation, and purification, and more particularly, but not exclusively, to a method and system for treating contaminated water via pH-optimized photodegradation.

According to an aspect of some embodiments of the present invention there is provided a method for treating contaminated water, the method comprising:
(a) identifying a target water contaminant in the contaminated water;
(b) identifying an optimal pH value for photodegradation of the identified target water contaminant;
(c) adjusting a pH of the contaminated water to the optimal pH value of the identified target water contaminant, for forming pH-adjusted contaminated water at the optimal pH value; and
(d) subjecting the pH-adjusted contaminated water to irradiation selected capable of causing photodegradation of the identified target water contaminant, such that a concentration of the target water contaminant is reduced, thereby treating the contaminated water.

According to an aspect of some embodiments of the present invention there is provided a system for treating contaminated water, the system comprising:

a receiving unit, suitable for receiving and/or transporting the contaminated water;

a contaminant identification unit for identifying a contaminant in the contaminated water, being in communication with the receiving unit;

a pH adjustment unit operatively connected to the receiving unit, suitable for adjusting a pH of the contaminated water to an optimal pH value for photodegradation of an identified water contaminant in the contaminated water, to thereby form pH-adjusted contaminated water at the optimal pH value;

a photolytic reactor unit operatively connected to the pH adjustment unit, for subjecting the pH-adjusted contaminated water to photodegradation of the identified water contaminant by irradiation, so as to reduce a concentration of the identified water contaminant, to thereby obtain treated water; and

an output unit operatively connected to the photolytic reactor unit, suitable for containing and/or transporting the treated water.

According to an aspect of some embodiments of the present invention there is provided a database listing a plurality of water contaminants and a corresponding plurality of optimal pH values for photodegradation of each the water contaminants.

According to an aspect of some embodiments of the present invention there is provided a process for forming the database described herein, the process comprising determining a plurality of optimal pH values for a corresponding plurality of water contaminants, and entering the optimal pH values and the water contaminants in the memory of a database.

According to some embodiments of the invention, identifying the optimal pH value for photodegradation of the identified target water contaminant is performed using a database listing a plurality of target water contaminants and a corresponding plurality of optimal pH values for photodegradation of each of the target water contaminants.

According to some embodiments of the invention, the method described herein further comprises, subsequent to identifying the target water contaminant, providing a database listing a plurality of target water contaminants and a corresponding plurality of optimal pH values for photodegradation of the target water contaminants.

According to some embodiments of the invention, the system further comprises a computerized database listing a plurality of water contaminants and a corresponding plurality of optimal pH values for photodegradation of the water contaminants, the computerized database being communicated with the contaminant identification unit.

According to some embodiments of the invention, the system further comprises a control unit, being communicated with the computerized database and the contaminant identification unit, and configured for using the database for identifying the optimal pH value for the identified water contaminant.

According to some embodiments of the invention, the control unit is further communicated to the receiving unit, to the pH adjusting unit, to the photodegradation unit and/or to the output unit.

According to some embodiments of the invention, the control unit is configured for treating a plurality of multiple contaminants simultaneously.

According to some embodiments of the invention, the irradiation comprises ultraviolet irradiation.

According to some embodiments of the invention, the photodegradation is direct photodegradation.

According to some embodiments of the invention, adjusting the pH of the contaminated water comprises adjusting the pH to a value in a range of 4 to 9.

According to some embodiments of the invention, adjusting the pH of the contaminated water comprises adjusting the pH to a value in a range of 5 to 8.

According to some embodiments of the invention, the contaminated water comprises a plurality of target water contaminants, and the method described herein comprising performing the (a)-(d) procedures described herein for each of the target water contaminants.

According to some embodiments of the invention, the water contaminant is an organic compound.

According to some embodiments of the invention, the organic compound is biologically active.

According to some embodiments of the invention, the biologically active organic compound is a pharmaceutical compound.

According to some embodiments of the invention, the pharmaceutical compound is an antibiotic.

According to some embodiments of the invention, the biologically active organic compound is an agrochemical.

According to some embodiments of the invention, the agrochemical is a pesticide.

According to some embodiments of the invention, the photodegradation comprises ultraviolet irradiation.

According to some embodiments of the invention, the optimal pH values are within a range of 4 to 9.

According to some embodiments of the invention, the optimal pH values are within a range of 5 to 8.

According to some embodiments of the invention, the plurality of water contaminants comprises a plurality of organic compounds.

According to some embodiments of the invention, the plurality of organic compounds comprises a plurality of biologically active organic compounds.

According to some embodiments of the invention, the plurality of biologically active organic compounds comprises at least one pharmaceutical compound.

According to some embodiments of the invention, the at least one pharmaceutical compound comprises at least one antibiotic.

According to some embodiments of the invention, the plurality of biologically active organic compounds comprises at least one agrochemical.

According to some embodiments of the invention, the at least one agrochemical comprises at least one pesticide.

The present invention, in some embodiments thereof, is implemented by performing steps or procedures, and sub-steps or sub-procedures, in a manner selected from the group consisting of manually, semi-automatically, fully automatically, and a combination thereof, involving use and operation of system units, system sub-units, devices, assemblies, sub-assemblies, mechanisms, structures, components, and elements, and, peripheral equipment, utilities, accessories, and materials. Moreover, according to actual steps or procedures, sub-steps or sub-procedures, system units, system sub-units, devices, assemblies, sub-assemblies, mechanisms, structures, components, and elements, and, peripheral equipment, utilities, accessories, and materials, used for implementing a particular embodiment of the disclosed invention, the steps or procedures, and sub-steps or sub-procedures, are performed by using hardware, software, or/and an integrated combination thereof, and the system units, sub-units, devices, assemblies, sub-assemblies, mechanisms, structures, components, and elements, and, peripheral equipment, utilities, accessories, and materials, operate by using hardware, software, or/and an integrated combination thereof.

For example, software used, via an operating system, for implementing the present invention, in some embodiments thereof, can include operatively interfaced, integrated, connected, or/and functioning written or/and printed data, in the form of software programs, software routines, software sub-routines, software symbolic languages, software code, software instructions or protocols, software algorithms, or a combination thereof. For example, hardware used for implementing the present invention, in some embodiments thereof, can include operatively interfaced, integrated, connected, or/and functioning electrical, electronic or/and electromechanical system units, sub-units, devices, assemblies, sub-assemblies, mechanisms, structures, components, and elements, and, peripheral equipment, utilities, accessories, and materials, which may include one or more computer chips, integrated circuits, electronic circuits, electronic sub-circuits, hard-wired electrical circuits, or a combination thereof, involving digital or/and analog operations. The present invention, in some embodiments thereof, can be implemented by using an integrated combination of the just described exemplary software and hardware.

In exemplary embodiments of the present invention, steps or procedures, and sub-steps or sub-procedures, can be performed by a data processor, such as a computing platform, for executing a plurality of instructions. Optionally, the data processor includes volatile memory for storing instructions or/and data, or/and includes non-volatile storage, for example, a magnetic hard-disk or/and removable media, for storing instructions or/and data. Optionally, exemplary embodiments of the present invention include a network connection. Optionally, exemplary embodiments of the present invention include a display device and a user input device, such as a keyboard or/and ‘mouse’.

### BRIEF DESCRIPTION OF THE DRAWINGS

Exemplary embodiments of the present invention are herein described, by way of example only, with reference to the accompanying drawings. With specific reference now to the drawings in detail, it is stressed that the particulars shown are by way of example and for purposes of illustrative description of embodiments of the present invention. In this regard, the description taken together with the accompanying drawings make apparent to those skilled in the art how the embodiments of the present invention may be practiced.

In the drawings:

FIG. 1 is a (block-type) flow diagram of an exemplary method for treating contaminated water via pH-optimized photodegradation, in accordance with some embodiments of the present invention;

FIG. 2 is a schematic diagram illustrating an exemplary system for treating contaminated water via pH-optimized photodegradation, which is suitable for implementing the method presented in FIG. 1, in accordance with some embodiments of the present invention;

FIG. 3 is a schematic diagram illustrating an exemplary polychromatic UV [200-400 nm] medium-pressure (MP) Hg vapor lamp type collimated beam apparatus for performing direct photolytic experiments, in accordance with some embodiments of the present invention;

FIG. 4 is an exemplary empirically determined graphical plot (spectrum) of Absorbance [1/cm] of exemplary antibiotics sulfamethoxazole (SMX) and sulfadimethoxine (SMT) each at concentration of 1 μg/ml {left y-axis} and UV lamp irradiance [μW/cm²] {right y-axis}, as a function of Wavelength [nm], showing overlap between the absorption spectra of SMX, SMT and the emission spectrum of the UV lamp, as described hereinbelow in Example 1, in accordance with some embodiments of the present invention;

FIG. 5 is a schematic diagram illustrating a ‘parallel’ type exemplary system, based on the embodiment of the system illustrated in FIG. 2, for treating contaminated water via pH optimized photolysis, according to a [multi-water contaminant treatment/‘parallel’ configuration], wherein two separate contaminated water external sources, each containing a different target water contaminant, are treated in parallel according to a ‘parallel’ configuration (mode) of implementation of the method steps and system units, in accordance with some embodiments of the present invention;

FIG. 6 is a schematic diagram illustrating a ‘series’ type exemplary system for treating contaminated water via pH optimized photolysis, based on the embodiment of the system illustrated in FIG. 2, according to a [multi-water contaminant treatment/‘series’ configuration], wherein a single contaminated water external source containing two different target water contaminants is treated in series according to a ‘series’ configuration (mode) of implementation of the method steps and system units, in accordance with some embodiments of the present invention;

FIG. 7 is an exemplary empirically determined graphical plot of the (UV) direct photolytic degradation [in terms of Ln (C_{H}/C₀)] of the exemplary antibiotic sulfamethoxazole (SMX) in deionized (DI) water, as a function of (UV) Fluence (dose (H)) [mJ/cm²], at different pH values (5, 6, 7); the dashed line represents extrapolation for 90% degradation of the initial amount of SMX, as described herein below in Example 1, in accordance with some embodiments of the present invention;

FIG. 8 is an exemplary empirically determined graphical plot of the (UV) direct photolytic degradation [in terms of Ln (C_{H}/C₀)] of the exemplary antibiotic sulfadimethoxine (SMT) in deionized (DI) water, as a function of (UV) Fluence (dose (H)) [mJ/cm²], at different pH values (5, 6, 7); the dashed line represents extrapolation for 90% degradation of the initial amount of SMT, as described herein below in Example 1, in accordance with some embodiments of the present invention;

FIG. 9 is a schematic diagram illustrating an exemplary embodiment of the acid [water pH<5.7]—base [water pH>5.7] speciation of the exemplary antibiotic SMX;

FIG. 10 is an exemplary empirically determined graphical plot of the (UV) direct photolytic degradation [in terms of Ln (C_{H}/C₀)] of the exemplary antibiotic sulfamethoxazole (SMX) in synthetic effluent water, as a function of (UV) Fluence (dose (H)) [mJ/cm²], at different pH values (5, 6, 7); the dashed line represents extrapolation for 90% degradation of the initial amount of SMX, as described herein below in Example 1, in accordance with some embodiments of the present invention;

FIG. 11 is an exemplary empirically determined graphical plot of the (UV) direct photolytic degradation [in terms of Ln (C_{H}/C₀)] of the exemplary antibiotic tetracycline (TC) in deionized (DI) water, as a function of (UV) Fluence (dose (H)) [mJ/cm²], at different pH values (5, 6, 7); the dashed line represents extrapolation for 90% degradation of the initial amount of TC, as described herein below in Example 2, in accordance with some embodiments of the present invention;

FIG. 12 is an exemplary empirically determined graphical plot of the (UV) direct photolytic degradation [in terms of Ln (C_{H}/C₀)] of the exemplary antibiotic oxytetracycline (OTC) in deionized (DI) water, as a function of (UV) Fluence (dose (H)) [mJ/cm²], at different pH values (5, 6, 7); the dashed line represents extrapolation for 90% degradation of the initial amount of OTC, as described herein below in Example 2, in accordance with some embodiments of the present invention;

FIG. 13 is an exemplary empirically determined graphical plot of the (UV) direct photolytic degradation [in terms of Ln (C_{H}/C₀)] of the exemplary antibiotic amoxicillin (AMX) in deionized (DI) water, as a function of (UV) Fluence (dose (H)) [mJ/cm²], at different pH values (6, 7, 8); the dashed line represents extrapolation for 90% degradation of the initial amount of AMX, as described herein below in Example 2, in accordance with some embodiments of the present invention;

FIG. 14 is an exemplary empirically determined graphical plot of the (UV) direct photolytic degradation [in terms of Ln (C_{H}/C₀)] of the exemplary antibiotic ampicillin (AMP) in deionized (DI) water, as a function of (UV) Fluence (dose (H)) [mJ/cm²], at different pH values (6, 7, 8); including data points for 90% degradation of the initial amount of AMP, as described herein below in Example 2, in accordance with some embodiments of the present invention;

FIG. 15 is an exemplary empirically determined graphical plot of the (UV) direct photolytic degradation [in terms of Ln (C_{H}/C₀)] of the exemplary antibiotic ciprofloxacin (CPR) in deionized (DI) water, as a function of (UV) Fluence (dose (H)) [mJ/cm²], at different pH values (5, 6, 7); the dashed line represents extrapolation for 90% degradation of the initial amount of CPR, as described herein below in Example 2, in accordance with some embodiments of the present invention;

FIG. 16 is an exemplary empirically determined graphical plot of the (UV) direct photolytic degradation [in terms of Ln (C_{H}/C₀)] of the exemplary antibiotic enrofloxacin (ENR) in deionized (DI) water, as a function of (UV) Fluence (dose (H)) [mJ/cm²], at different pH values (5, 6, 7); the dashed lines represent extrapolation for 90% degradation of the initial amount of ENR, as described herein below in Example 2, in accordance with some embodiments of the present invention;

FIG. 17 is an exemplary empirically determined graphical plot of the (UV) direct photolytic degradation [in terms of Ln (C_{H}/C₀)] of the exemplary antibiotic norfloxacin (NOR) in deionized (DI) water, as a function of (UV) Fluence (dose (H)) [mJ/cm²], at different pH values (5, 6, 7); the dashed lines represent extrapolation for 90% degradation of the initial amount of NOR, as described herein below in Example 2, in accordance with some embodiments of the present invention;

FIG. 18 is an exemplary empirically determined graphical plot of the (UV) direct photolytic degradation [in terms of Ln (C_{H}/C₀)] of the exemplary antibiotic trimethoprim (TMP) in deionized (DI) water, as a function of (UV) Fluence (dose (H)) [mJ/cm²], at different pH values (6, 7, 8); the dashed lines represent extrapolation for 90% degradation of the initial amount of TMP, as described herein below in Example 2, in accordance with some embodiments of the present invention;

FIG. 19 is an exemplary empirically determined graphical plot of the (UV) direct photolytic degradation [in terms of Ln (C_{H}/C₀)] of the exemplary antiepileptic carbamazepine (CPZ) in deionized (DI) water, as a function of (UV) Fluence (dose (H)) [mJ/cm²], at different pH values (6, 7, 8); the dashed lines represent extrapolation for 90% degradation of the initial amount of CPZ, as described herein below in Example 2, in accordance with some embodiments of the present invention;

FIG. 20 is an exemplary empirically determined graphical plot of the (UV) direct photolytic degradation [in terms of Ln (C_{H}/C₀)] of the exemplary pesticide pyriproxyfen (PRX) in deionized (DI) water, as a function of (UV) Fluence (dose (H)) [mJ/cm²], at different pH values (3, 4, 5); including data points for 90% degradation of the initial amount of AMP, as described herein below in Example 3, in accordance with some embodiments of the present invention;

FIG. 21 is an exemplary empirically determined graphical plot of the (UV) direct photolytic degradation rate constant [k (cm²/mJ)] of each of the exemplary antibiotics sulfamethoxazole (SMX), oxytetracycline (OTC) and ciprofloxacin (CPR), studied singly (i.e., separately), in deionized (DI) water, as a function of pH values (5-7); based on the empirical data illustrated in FIG. 7 (Example 1), FIG. 12 (Example 2) and FIG. 15 (Example 2), respectively, as described herein below in Example 4, in accordance with some embodiments of the present invention;

FIG. 22 is an exemplary empirically determined graphical plot of the (UV) direct photolytic degradation [in terms of Ln (C_{H}/C₀)] of each of the exemplary antibiotics sulfamethoxazole (SMX), oxytetracycline (OTC) and ciprofloxacin (CPR), studied in combination (i.e., mixed together), in deionized (DI) water, as a function of Time [min] at different pH values (5, 7), as described herein below in Example 4, in accordance with some embodiments of the present invention; and

FIG. 23 is an exemplary empirically determined graphical plot of the (UV) direct photolytic degradation rate constant [k (cm²/mJ)] of each of the exemplary antibiotics sulfadimethoxine (SMT), tetracycline (TC), amoxicillin (AMX), norfloxacin (NOR) and trimethoprim (TMP), studied singly (i.e., separately), in deionized (DI) water, as a function of pH values (5-8); based on the empirical data illustrated in FIG. 8 (Example 1), FIG. 11 (Example 2), FIG. 13 (Example 2), FIG. 17 (Example 2) and FIG. 18 (Example 2), respectively, as described herein below in Example 5, in accordance with some embodiments of the present invention.

### DESCRIPTION OF EXEMPLARY EMBODIMENTS OF THE INVENTION

The present invention, in some embodiments thereof, relates to the field of water treatment, remediation, and purification, and more particularly, but not exclusively, to a method and system for treating contaminated water via pH-optimized photodegradation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

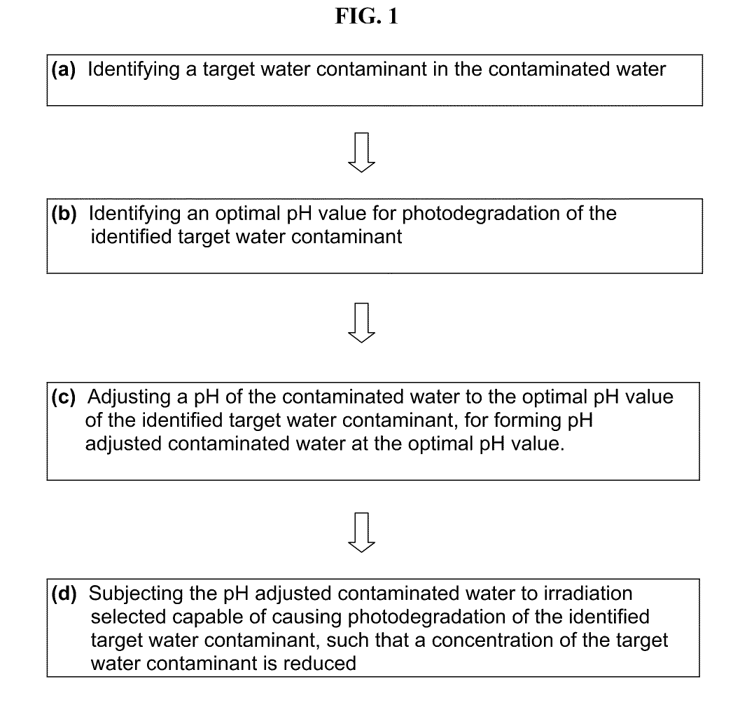

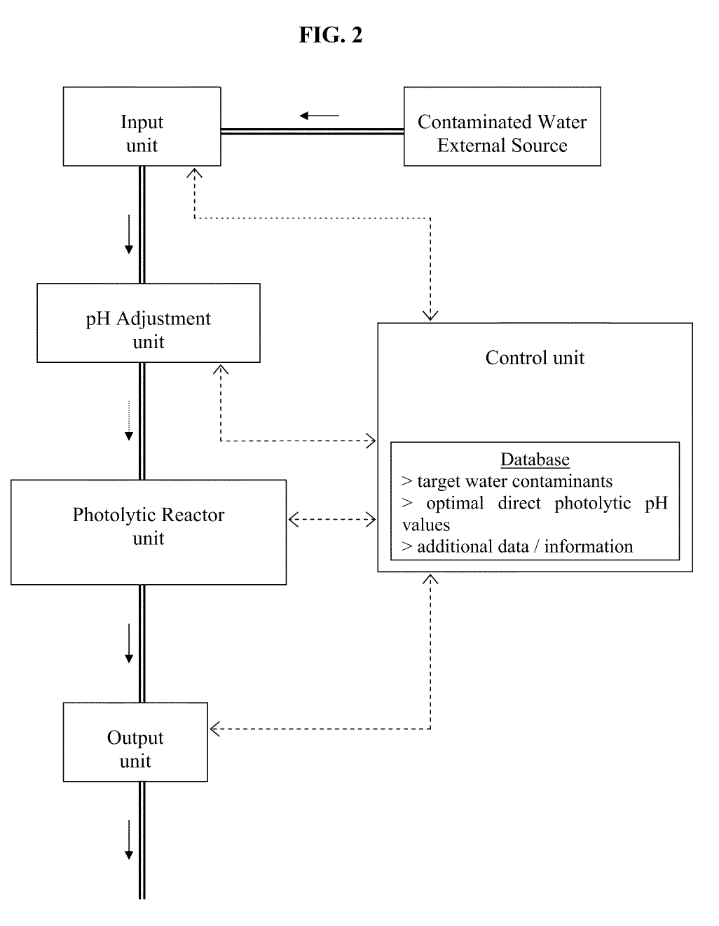

Referring now to the drawings, FIG. 1 is a (block-type) flow diagram of an exemplary method for treating contaminated water via pH optimized photodegradation, according to some embodiments of the present invention. FIG. 2 is a schematic diagram illustrating an exemplary system for treating contaminated water via pH optimized photodegradation, which is suitable for implementing the method presented in FIG. 1.

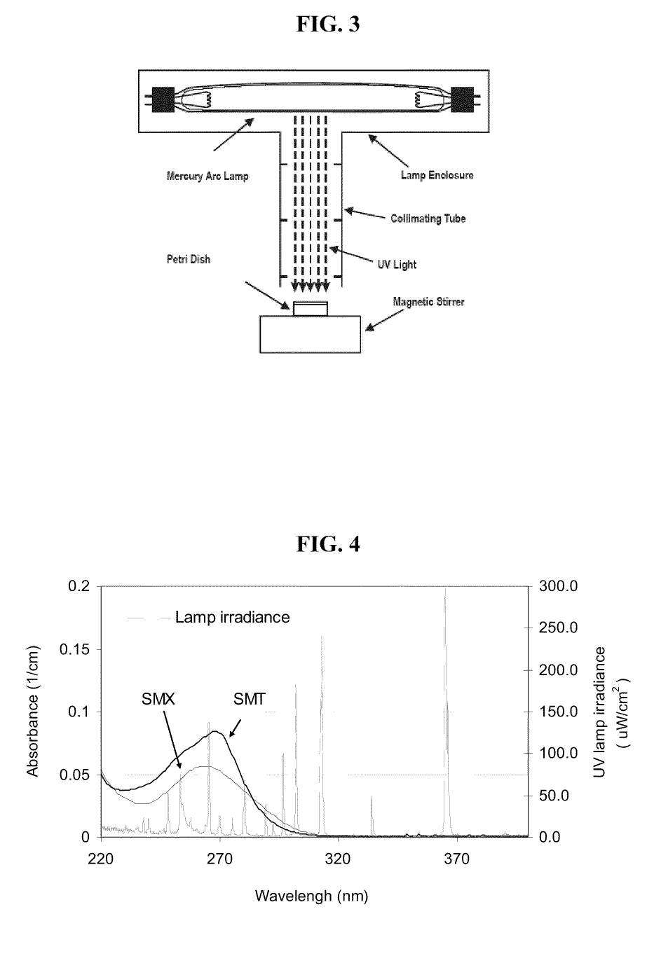

FIG. 3 is a schematic diagram illustrating an exemplary polychromatic UV [200-400 nm] medium-pressure (MP) Hg vapor lamp type collimated beam apparatus for performing direct photolytic experiments, in accordance with some embodiments of the present invention.

FIG. 4 is an exemplary empirically determined graphical plot (spectrum) of absorbance of exemplary antibiotics as a function of wavelength of irradiation, showing overlap between the absorption spectra of SMX, SMT and the emission spectrum of the UV lamp, in accordance with some embodiments of the present invention.

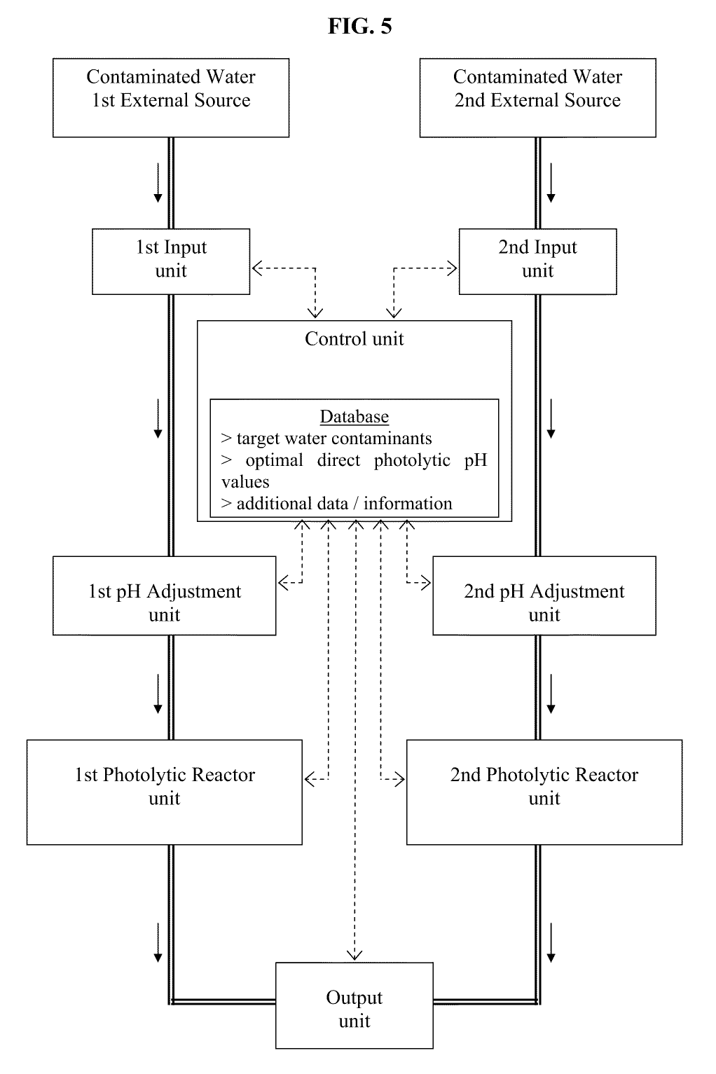

FIG. 5 is a schematic diagram illustrating a ‘parallel’ type exemplary specific optional embodiment of a system, based on the embodiment of the system illustrated in FIG. 2, for treating contaminated water. FIG. 6 is a schematic diagram illustrating a ‘series’ type exemplary embodiment of a system for treating contaminated water, based on the embodiment of the system illustrated in FIG. 2.

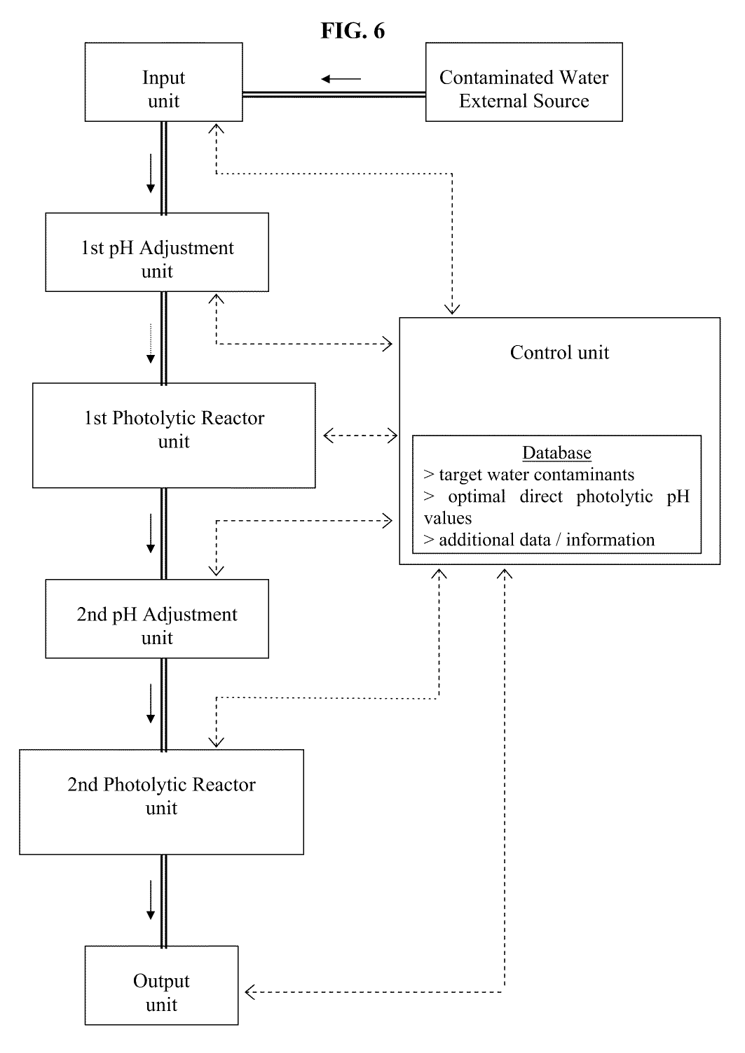

FIGS. 7, 8, 10-21 and 23 present empirically determined data which show a dependence of photodegradation rates of exemplary compounds on pH, allowing determination of an optimal pH value according to some embodiments of the present invention.

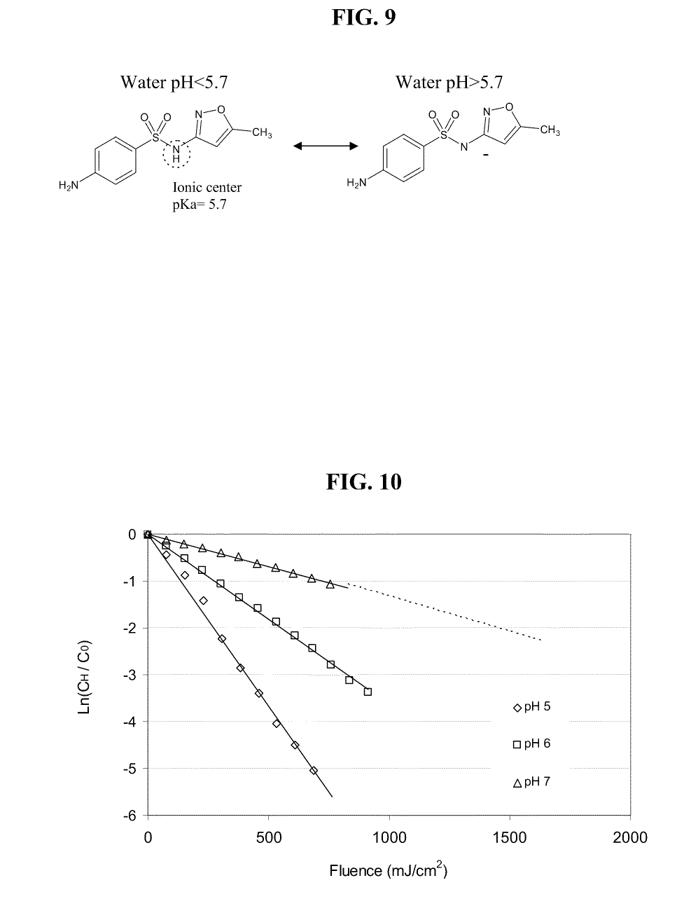

FIG. 9 is a schematic diagram illustrating an exemplary embodiment of the acid and base speciation of the exemplary antibiotic SMX.

FIG. 22 presents data exemplifying photolytic degradation of a mixture of exemplary compounds using different optimal pH values, according to some embodiments of the present invention.

The present invention, in some embodiments thereof, is generally applicable to (on-site or off-site; flow mode or batch mode) photolytic treatment of any of a wide variety of different types of contaminated water sources, particularly those originating from, or/and associated with, industrial or commercial, governmental, or residential, facilities or/and infrastructure involved with collecting, processing, recycling, or/and disposing, of large quantities of contaminated water, where the contaminated water contains any number or combination of a wide variety of different types or kinds of contaminants which can be photodegraded. The present invention, in some embodiments thereof, is readily commercially applicable, practical, and economically feasible to implement.

The phrase ‘contaminated water’, as used herein, generally refers to water which contains any number or combination of a wide variety of different types, kinds, and forms, of contaminants. Typically, the contaminated water is in a liquid phase, but may also be in a vapor phase, or in a jet stream or spray type of phase or form. The phrase ‘contaminated water’, as used herein, is considered equivalent to, and synonymous with, the term ‘wastewater’ and the phrase ‘waste water’ (i.e., water containing waste(s)), the phrase ‘polluted water’ (i.e., water containing pollutant(s)), and the phrase ‘impure water’ (i.e., water containing impurity(ies)).

Selected (general) definitions of ‘photodegradation’ are as follows.

‘Photodegradation’ can be generally defined and described as follows [10]: “degradation of a photodegradable molecule caused by the absorption of photons, particularly those wavelengths found in sunlight, such as infrared radiation, visible light and ultraviolet light”; and as including “photodissociation, the breakup of molecules into smaller pieces by photons” and also “the change of a molecule's shape to make it irreversibly altered, such as the denaturing of proteins, and the addition of other atoms or molecules”.

‘Photodegradation’ can also be generally defined and described as follows [11]: “The photochemical transformation of a molecule into lower molecular weight fragments, usually in an oxidation process”.

The terms “photodegradation” and “photolysis” are used herein interchangeably, and are considered herein to be synonymous.

‘Photolysis’ can also be generally defined and described as follows [12]: “The process by which a chemical species undergoes a chemical change as the result of the absorption of photons”.

Throughout the scientific, technical, and patent, literature, the general terms ‘photolysis’ and ‘photodegradation’, in addition to the preceding stated synonymous, alternative, or related, terms of ‘photodissociation and ‘photodecomposition’, is also referred to as, or/and associated with, the terms of ‘photochemical oxidation’, ‘photo-oxidation’, and ‘photooxidation’.

As used herein, the terms “photolytic” and “photolytic treatment” encompass photolysis, photodegradation, photooxidation, photodecomposition and photodis sociation.

An aspect of the present invention, in some embodiments thereof, is of a method for treating contaminated water, which is effected by: (a) identifying a target water contaminant in the contaminated water to be treated; (b) identifying an optimal pH value for photodegradation of the identified target water contaminant; (c) adjusting a pH of the contaminated water to the optimal pH value for photodegradation of the identified target water contaminant, for forming pH adjusted contaminated water at the optimal pH value for the identified contaminant; and (d) subjecting the pH-adjusted contaminated water to irradiation (e.g., ultraviolet (UV) irradiation) selected capable of causing photodegradation of the identified target water contaminant, such that a concentration of the identified target water contaminant is reduced.

According to some embodiments, the contaminated water comprises a plurality of target water contaminants, and the abovementioned (a)-(d) procedures are performed for each of the target water contaminants.

As used herein, the term “reduced” refers to a reduction of a concentration by at least 20%. Optionally, the concentration of the identified contaminant is reduced by at least 50%, optionally by at least 80%, and optionally at least 90%. According to optional embodiments, the concentration of a contaminant is reduced such that the contaminant becomes substantially absent from the water (e.g., 100% reduction).

The term ‘pH’, as used herein, refers to the measure of the acidity or alkalinity of an aqueous solution. pH can be defined by the equation:

pH=−log₁₀[H]⁺

where [H]⁺ is the concentration of H⁺ in the aqueous solution.

As used herein, the phrase “optimal pH value for photodegradation”, also referred to herein as “optimal pH value”, refers to a pH value at which a rate of photodegradation is greatest for a particular contaminant. For contaminants wherein the optimal pH value is dependent on the treatment conditions (e.g., wavelength(s) of irradiation), an optimal pH value is optionally selected for conditions identical to (e.g., with respect to wavelength(s) of irradiation), or at least similar to, the irradiation selected for causing photodegradation of the contaminant, as described hereinabove.

Optionally, the optimal pH value is selected from a finite set of possible values (e.g., round numbers). Such possible values may comprise values at regular intervals, such as 5, 6, 7, 8, etc., or 5.1, 5.2, 5.3, 5.4, etc.

The use of highly acidic or highly alkaline conditions may be disadvantageous for any of a variety of reasons. For example, such conditions may harm an apparatus used for treating the contaminated water and/or may be environmentally harmful due to a presence of high concentrations of acid or base in the treated water. In addition, the use of high concentrations of acid and/or base may be excessively costly.

Hence, according to some embodiments of the present invention, the pH of the contaminated water is adjusted to a value within a range of moderate acidity and/or alkalinity (e.g., from pH 2 to pH 10). Thus, optionally, pH values above 4, optionally above 4.5, and optionally above 5, are used. In addition, optionally, pH values below 10, optionally below 9, and optionally below 8, are used.

It is to be appreciated that for embodiments in which pH values within a particular range are used, the optimal pH value is to be defined accordingly as referring to a pH value within that range at which a rate of photodegradation of is greatest for a particular contaminant.

Optimal pH values may be determined by testing photodegradation of target contaminants at different pH values, and comparing the photodegradation rates at different pH values so as to determine the optimal pH value, as exemplified hereinbelow in the Examples section. Optionally, in addition to experimental data, calculations (e.g., interpolation and/or extrapolation) are used to determine optimal pH values. Thus, for example, if experimental data indicates that photodegradation of a compound is more rapid at pH 6 than at pH 7, and more rapid at pH 7 than at pH 8, the a pH lower than 6 (e.g., pH 5) may be considered as being an optimal pH, based on extrapolation of the experimental data. Optimal pH values of a contaminant may optionally also be obtained by analyzing chemical structure and predicting an optimal pH value based on data for one or more compound characterized by a related chemical structure.

Without being bound by any particular theory, it is believed that adjustment of a pH to an optimal pH value brings an ionic center of a contaminant molecule to a form (e.g., negatively charged, neutrally charged or positively charged) in which the contaminant molecule is most readily photodegraded.

Adjustment of the pH is optionally effected by adding an acid or base, as needed, at a suitable volume and concentration. The volume and/or concentration of acid or base to be added in order to obtain the desired optimal pH value may be determined by measuring a pH of the contaminated water and calculating the volume and/or concentration, of the acid and/or base, necessary to convert the measured pH value to the optimal pH value. Alternatively, the acid and/or base may be added in a fixed amount, wherein following addition of each fixed amount, a pH of the contaminated water is measured in order to determine whether an additional fixed amount is required. More than one fixed amount is optionally used, for example, such that a relatively large fixed amount is used when the measured pH value is far from the desired optimal pH value, and a relatively small fixed amount is used when the measured pH value is close to the desired optimal pH value.

Measuring the pH value can be performed using methods well known in the art. In some embodiments, measuring the pH value is performed using a pH meter being in communication with the contaminated water or a sample thereof.

Addition of the acid and/or base so as to adjust the pH can be performed manually, semi-automatically or fully-automatically. For example, a desired amount of an acid and/or base can be calculated based on the volume of the contaminated water to be treated, and added manually to the contaminated water. The pH of the contaminated water is then measured and the need to add additional aliquot(s) of an acid and/or base is determined. Alternatively, fixed amounts of an acid and/or base are added automatically, and the pH is measured after each addition, whereby once a desired pH is achieved, the automated addition of the acid and/or base is ceased.

Optionally, the water is neutralized to an environmentally non-harmful pH value (e.g., 6-8) after treatment. Neutralization is readily effected by adding a base if the treated water is more acidic than desired and by adding an acid if the treated water is more basic than desired.

In some embodiments, the acid and/or base are selected so as to be environmentally non-harmful. Thus, for example, the acid (e.g., HCl) and/or the base (e.g., NaOH) are selected so as to form non-harmful byproducts (e.g., NaCl) when neutralized. Accordingly, in some embodiments, the acid is HCl, which is neutralized after treatment with NaOH, and vice versa. Other acids, bases and corresponding neutralizing bases and acid can be readily determined by a person skilled in the art, and are also contemplated.

According to some embodiments, identifying the optimal pH value of the identified contaminant is performed using a database listing a plurality of target water contaminants and a corresponding plurality of optimal pH values of the contaminants.

The optimal pH values are optionally selected so as to be within a particular range of pH values and/or so as to represent an optimal pH value of photodegradation under particular conditions (e.g., ultraviolet radiation), as described herein.

As used herein, “determining” an optimal pH value encompasses any method for obtaining an optimal pH value, including, without limitation, experimenting to obtain data revealing an optimal pH value, calculating an optimal pH value, and obtaining an optimal pH value which has been reported (e.g., in scientific literature), as further detailed herein.

Optionally, the database lists a single optimal pH value per contaminant.

Alternatively, the database lists a plurality of optimal pH values for at least a portion of the contaminants, each value representing an optimal pH value under different conditions, as well as the conditions at which each value is an optimal pH value. Such a database can therefore be used to select an optimal pH value for a contaminant under selected conditions (e.g., type and condition of irradiation).

According to optional embodiments, the method further comprises providing a database as described herein, subsequent to identifying the target water contaminant.

A database may optionally be compiled by experimentally testing a plurality of potential water contaminants in order to determine an optimal pH value (or plurality of optimal pH values) for each potential contaminant, as described herein, followed by entry of the optimal pH values so determined into the database.

Alternatively or additionally, empirical data, for example, photodegradation rates and/or radiation doses required to achieve a given reduction (e.g., 90%) in concentration for a contaminant at different pH values, may be entered into the database. The database is configured to determine and list the optimal pH value based on the empirical data. In some embodiments, the database determines an optimal pH value by calculation (e.g., via interpolation or extrapolation) using appropriate logical decision making criteria (e.g., a computerized algorithm).

As described hereinabove, it is believed that a rate of photodegradation of a contaminant is affected by a degree of protonation of an ionic center of the contaminant. Hence, it is believed that a rate of photodegradation is most pH-dependent when the pH value is close to a pKa value (e.g., in a range from pKa−1 to pKa+1) associated with the ionic center of the contaminant.

The term “pKa” refers to the strength of an acid: the larger the value, the weaker the acid. pKa is the pH value were 50% of the molecules are protonated and 50% non-protonated.

At any pH value well below the pKa value, nearly 100% of the molecules will be protonated, and at any pH value well above the pKa value, nearly 100% of the molecules will be non-protonated. Hence, there is little expectation that adjustment of a pH value to well above or well below the pKa value will provide any significant additional benefit with respect to a rate of photodegradation than adjustment of a pH value to a value moderately above (e.g., pKa+1) or moderately below (e.g., pKa−1) the pKa value.

In some embodiments, interpretation of data by a database (e.g., via interpolation or extrapolation) includes consideration of a pKa value of a contaminant.

Optionally the database further lists pKa values of contaminants.

The database may be readily updatable, by entering new optimal pH values and/or new data for determining an optimal pH value and/or values and data for new contaminants into the database.

Optimization of the pH value for photodegradation of a contaminant, as described herein, enhances the effectiveness of irradiation at degrading the contaminant. The increase of effectiveness of irradiation is particularly advantageous for direct photodegradation (i.e., direct photolysis) methods, wherein irradiation is the sole effector of contaminant degradation, as effectiveness of irradiation is potentially a significant limiting factor in the applicability of direct photodegradation.

Hence, according to some embodiments of each of the aspects of the invention, the photodegradation is direct photodegradation.

As used herein, the phrases “direct photodegradation” and “direct photolysis” refer to transformation of a compound due to its absorption of photons. If a molecule absorbs a photon (IR, VIS, UV), it is then in an excited state and can more readily transform [12].

As used herein, the phrases “indirect photodegradation” and “indirect photolysis” refer to transformation of a compound due to its interaction with a reactant generated by the influence of photons. An intermediate molecule absorbs photons, becomes excited and reacts with the pollutant (i.e., water contaminant) [12].

Without being bound by any particular theory, it is believed that the fundamental, mechanisms underlying direct photodegradation are generally different from those underlying indirect photodegradation. It is thus believed that any pH effects which are observed for indirect photodegradation may relate partially or exclusively to the properties of the light-sensitive reagent used in indirect photodegradation and/or products formed by interaction between the light-sensitive reagent and light, and therefore such pH effects cannot be assumed to reflect the properties of a particular contaminant. Accordingly, pH effects observed for indirect photodegradation are not necessarily applicable or extendable to practicing direct photodegradation. Similarly, pH effects observed for direct photodegradation are not always applicable or extendable to indirect photodegradation.

Once the pH of the contaminated water is adjusted, the water is subjected to irradiation, so as to effect photodegradation. The type of irradiation (e.g., ultraviolet or visible light) will depend on the target water contaminants and their absorption spectra. In general, ultraviolet light is suitable for photodegrading a far wider variety of contaminants than is visible light, whereas visible light is suitable for irradiating at high doses at low cost, provided that the target contaminant(s) absorb visible light.

In some embodiments, the type of degradation is determined by the database described herein. As noted hereinabove, the database may provide an optimal pH for photodegradation under various conditions. Accordingly, the most suitable conditions for performing the photodegradation can be deduced, using e.g., appropriate logical decision making criteria (e.g., a computerized algorithm).

In some embodiments, the irradiation is performed using an ultraviolet light source. Two types of mercury lamp are commonly used as ultraviolet light sources for water treatment: (a) low pressure (LP) and LP-high output lamps, which are monochromatic with UV output at a single wavelength of 254 nm; and (b) medium pressure (MP) lamps, which are polychromatic with UV output at multiple wavelengths. However, other ultraviolet light sources are also contemplated.

A UV response is usually determined in a bench scale apparatus called collimated beam [37] in which part of the output of a UV lamp is directed onto a horizontal surface, down a long collimator, consisting of a cylindrical tube. The water to be irradiated is placed on the horizontal surface below the bottom of the collimator. The collimated beam components are described in references [37, 38], and are as follows:

1) Shutter—a mean by which to regulate the time of exposure factor in the fluence calculation.

2) Collimating tube—used to provide a spatially homogeneous irradiation field on a given surface area.

3) Platform—The platform on which the Petri dish and stirring motor is placed for UV exposure should be thermally and physically stable and easily raised or lowered. It needs vertical adjustment during UV exposure for proper irradiance measurement.

4) Stirring—During the UV exposure to assure equal fluence in the solution, it may be important to maintain adequate stirring.

The fluence rate is defined as the total radiant power incident from all directions onto an infinitesimally small sphere of cross-sectional area dA, divided by dA. In a well designed collimated beam apparatus, the fluence rate and the irradiance are virtually the same if assuming that there is no reflection or scattering.

When average irradiance or the average fluence rate is constant (e.g., in a collimated beam), multiplication by the exposure time (in seconds) gives the fluence. The term ‘fluence’ has been called the dose, however, ‘dose’ is a term that, in other contexts, is used to describe the total absorbed energy. The term fluence relates to the incident light energy, rather than absorbed light energy.

When a light beam of known wavelength (λ) enters a medium of path length d, absorbance is defined as:

A=e×Cᵢ×d (1)

where

A—is the light absorbance (unitless)

e—is the molar absorptivity or extinction coefficient (M⁻¹ cm⁻¹)

Cᵢ—is the molar concentration of organic compound (M)

d—is the path length from the light source (cm).

A254—is the Absorbance at specified wavelength (e.g., 254 nm for “A254”), based on 1 cm path length (unitless)

The radiometer or spectroradiometer sensor provides a measure of the incident irradiance on the water at the center of the beam. The average fluence rate is obtained by multiplying the incident irradiance with several correction factors as described in the following equation:

E_{avg}=E₀×Petri Factor×ReflectionFactor×WaterFactor

wherein the variables of the above equation are as follows:

E₀—is the incident irradiance readings by the radiometer sensor

E_{avg}—is the average germicidal fluence rate.

Reflection Factor (R)—For air and water, the average refractive indices in the 200-300 nm region are 1.000 and 1.372, respectively. Thus for interface between these two media R=0.025. The fraction of the incident beam that enters the water is 0.975 (1-R).

Petri Factor—The irradiance will vary somewhat over the surface area of the liquid sample to be irradiated. The Petri Factor is defined as the ratio of the average of the incident irradiance over the area of the Petri dish to the irradiance at the center of the dish. It is used to correct the irradiance reading at the center of the Petri dish to more accurately reflect the average incident fluence rate over the surface area. According to reference [38], a well designed collimated beam apparatus should be able to deliver a Petri Factor of greater than 90%.

Water Factor—if the water absorbs UV at the wavelengths of interest, then it is necessary to account for the decrease in irradiance arising from absorption as the beam passes through the water. The Water Factor is defined as:

$$WaterFactor = \frac{1 - {10}^{a l}}{a l ln ( 10 )}$$

where,

a—is the decadic absorption coefficient (cm⁻¹) or absorbance for a 1 cm path length that can be calculated according to Eq. 1.

l—is the vertical path length (cm) of the water in the Petri dish.

Calculating the UV dose in LP systems requires the measurements of incident irradiance, UV absorbance, sample depth and the factors (Reflection, Petri, Sensor). However determination of UV dose with MP lamps is more complex as they require also measurements of spectral incident irradiance.

In some embodiments, upon subjecting the water to irradiation, the presence and/or concentration of the water contaminant(s) is measured, so as to determine the extent of reduction of its concentration. This can be done as described hereinabove for identifying the contaminant(s).

In cases where the extent of reducing a concentration of a contaminant is below that desired, the method may further comprise re-subjecting the water to irradiation. Alternatively, selecting other conditions (e.g., other value of an optimal pH from the database and/or other type and/or procedure of irradiation) is effected.

As noted hereinabove, the treated water can be subjected to pH neutralization, as described hereinabove.

The various procedures of the water-treatment method described herein can be performed conveniently by a single system for treating contaminated water.

Thus, an aspect of the present invention, in some embodiments thereof, is of a corresponding system for treating contaminated water, the system comprising a receiving unit (also referred to herein as an “input unit”), suitable for receiving and/or transporting the contaminated water; a contaminant identification unit for identifying a contaminant in the contaminated water, being in communication with the receiving unit; a pH adjustment unit operatively connected to the receiving unit, suitable for adjusting a pH of the contaminated water to an optimal pH value for photodegradation of an identified water contaminant in the contaminated water, to thereby form pH adjusted contaminated water at the optimal pH value; a photolytic reactor unit operatively connected to the pH adjustment unit, for subjecting the pH adjusted contaminated water to photodegradation of the identified water contaminant by irradiation (e.g., UV irradiation), so as to reduce a concentration of the identified water contaminant, to thereby obtain treated water; and an output unit operatively connected to the photolytic reactor unit, suitable for containing and/or transporting the treated water.

According to optional embodiments, two or more of the abovementioned units are integrated into a single unit. Thus for example, pH adjustment and photolysis may optionally be performed in a single unit which operates both as a pH adjustment unit and a photolytic reactor unit. Alternatively or additionally, pH adjustment and contaminant identification may be performed by a single unit which operates both as a pH adjustment unit and a contaminant identification unit.

Further alternatively, the receiving unit serves also as a contaminant identification unit, as a pH adjustment unit and as a photolytic reactor. In such embodiments, water are transported to the receiving unit, contaminant(s) are identified, pH of the water is adjusted by adding to the receiving unit a desired amount of an acid and/or base, as described herein, and the water are then subjected to photolytic treatment in the receiving unit.

Further alternatively, once the water contaminants are identified, water is transported to a pH adjustment unit, and once pH of the water is adjusted to an optimal pH, water are transported to a photolytic reactor (see, for example, FIG. 2). According to an optional embodiment, the system further comprises a computerized database listing a plurality of water contaminants and a corresponding plurality of optimal pH values, as described herein. Optionally, the database is in communication with the contaminant identification unit, so as to facilitate identification of an optimal pH value of a contaminant identified by the contaminant identification unit. Thus, for example, once a target contaminant is identified by the identification unit, the obtained information is fed into the database and an output of an optimal pH value is provided. The database is optionally configured so as to perform any additional database function(s) described hereinabove (e.g., storing experimental data, calculating optimal pH values based on data, etc.).

According to an optional embodiment, the system further comprises a control unit, being communicated with the computerized database and the contaminant identification unit, and configured for using the database for identifying an optimal pH value of an identified water contaminant. In some embodiments, information regarding an identity of a water contaminant is passed from the contaminant identification unit to the control unit, and the control unit processes the information using the database to produce a signal indicating the optimal pH value. Optionally, if the identified contaminant is not listed in the database, a corresponding signal is produced by the control unit.

According to optional embodiments, the control unit is further communicated to the receiving unit, the pH adjustment unit, the photodegradation unit and/or the output unit.

Thus, in some embodiments, the control unit produces an output signal indicating an optimal pH value which is sent to the pH adjustment unit, so as to control the pH adjustment performed by the pH adjustment unit.

In some embodiments, the control unit is communicated with the receiving unit and/or the output unit, for controlling inlet and/or exit of water (e.g., opening and closing a passageway for inlet and/or exit of water, and/or modulating a rate of inlet and/or exit of water). Optionally, the control unit is configured so as to control inlet of water based on communication with another unit, for example, for allowing inlet of water when the pH adjustment unit is ready to receive contaminated water for pH adjustment.

Alternatively or additionally, inlet and/or exit of water from the system can be controlled manually.

The receiving unit optionally comprises an inlet port and/or an outlet port (e.g., valve) for controlling receiving contaminated water (e.g., entry of contaminated water into the system) and/or transporting contaminated water to one or more other units. Similarly, other units optionally and independently comprise an inlet port and/or an outlet port, for controlling receiving contaminated water (e.g., entry of contaminated water into the unit) and/or transporting contaminated water to another unit.

Each of the inlet and outlet ports can be operated manually, semi-automatically or automatically, via a control unit as described herein.

In some embodiments, the system further comprises at least one device (e.g., a pump) for causing the contaminated water to be treated to flow through the system. Optionally, such a device is operatively connected to the control unit, for example, so as to allow water flow to be reduced and/or stopped at one or more stage of treatment (e.g., after the contaminated water has flowed into a pH adjustment unit or photolytic reactor unit, but before pH adjustment or irradiation is complete), and then increased and/or restarted.

The contaminant identification unit is adapted so as to be capable of identifying a contaminant in the contaminated water (e.g., by spectroscopy, fluorometry, mass spectrometry and/or chromatography).

The system may optionally be configured such that substantially all contaminated water passes through the contaminant identification unit. Alternatively, the system is configured such that only a portion of the contaminated water is sampled and the contaminant(s) therein identified.

In some embodiments, the system is configured so as to monitor the identity of the contaminants constantly or at regular intervals, so as to allow adjustment of the selected optimal pH and/or irradiation time, as needed, if the contents of contaminated water changes.

In some embodiments, the system is configured so as to identify a contaminant in the water only at selected times, for example, when a new source of contaminated water enters the system or when a new source of a contaminant (e.g., a new industrial process) is connected to the source of contaminated water.

Optionally the control unit is configured so as to control when the contaminant identification unit tests the contaminated water in order to identify a contaminant.

pH adjustment is performed in accordance with the identity of the identified water contaminant. In some embodiments, the pH adjustment unit includes at least one container for containing an acid and at least one container for containing a base. Optionally, the containers are configured so as to be readily refilled with an acid or base when desired.

In some embodiments, the containers are operatively connected via a controllable exit (e.g., a system of valves and/or pipes) to a container for containing the contaminated water, so as to allow release of acid or base into the contaminated water in a controlled manner. The controllable exit is configured so as to open and close as needed. Optionally, the controllable exit has more than one “open” mode, wherein the different “open” modes allow different rates of release of acid or base into the contaminated water.

In some embodiments, the control unit is in communication with the pH adjustment unit, so as to allow control of the controllable exit by the control unit.

Optionally, the containers containing an acid and/or base are connected to the container for containing contaminated water via an intermediate container. In some embodiments acid or base enters the intermediate container until a predetermined amount of acid or base is present in the intermediate container. The acid or base exits the intermediate container into the container for the contaminated water.

In some embodiments, the control unit coordinates entry into the intermediate container and exit from the intermediate container, for example, by allowing exit of acid or base from the intermediate container and/or by preventing further entry of acid or base into the intermediate container only after the predetermined amount has entered the intermediate container.

Optionally, the system further comprises at least one device for determining a pH value of the contaminated water (hereinafter referred to as a “pH-meter”). A pH-meter is optionally a component of a pH adjustment unit. In some embodiments, a pH-meter is configured so as to repeatedly determine a pH during release of acid and/or base into the contaminated water, so as to determine when an optimal pH value has been achieved.

Optionally, pH adjustment is performed manually, for example, by manually adding an acid or base, and using a pH-meter manually to monitor the pH of the water, as detailed hereinabove.

In some embodiments, the pH meter is in communication with the control unit. Optionally, the control unit controls pH adjustment (e.g., determining an amount of acid or base to be added to the contaminated water) based on information received from the pH-meter. Optionally, the control unit controls operation of the pH meter (e.g., by causing the pH-meter to begin measuring a pH).

The photolytic reactor unit includes a source (e.g., a light source as described herein). A plurality of light sources are optionally included (e.g., light sources with different intensities and/or emission spectra). Optionally, the photolytic reactor unit includes a light source with different modes of irradiation (e.g., different intensities and/or emission spectra).

Optionally, the photolytic reactor unit includes a container for containing the contaminated water, wherein a light source irradiates the contaminated water through a transparent wall of the container. Optionally, at least one other wall of the container is highly reflective (e.g., mirrored), so as to increase a photolytic efficiency of the irradiation.

The light source(s) is optionally operated manually. Alternatively or additionally, the light source can be operated automatically or semi-automatically.

In some embodiment, the control unit is in communication with the photolytic reactor unit.

Optionally, the control unit determines a mode of irradiation (e.g., by determining a light source to be operated or a mode of a light source) and/or irradiation time. Control of the mode of operation is optionally based on information in the database.

Alternatively of additionally, the control unit is configured so as to coordinate operation of the photolytic reactor unit with the operation of other units (e.g., by being in communication with the different units), for example, operating the photolytic reactor unit (e.g., activating a light source, causing the reactor unit to be ready to receive contaminated water) when pH adjustment is completed or near completion, and/or causing treated water to exit photolytic reactor unit when the output unit is ready to contain and/or transport the treated water.

According to optional embodiments, the system described herein further comprises an additional pH adjustment unit configured to adjust a pH of treated water to a desired pH value (e.g., an environmentally non-harmful pH value). Optionally, the additional pH adjustment unit is operatively connected to the output unit and/or photolytic reactor unit described herein. The configuration of the additional pH adjustment unit is optionally substantially identical to the pH adjustment unit described previously herein, except that no connection to a database listing optimal pH values for photodegradation is needed.

In some embodiments, the photodegradation is direct photodegradation, as defined and described herein.

Optionally, the control unit is configured for treating a plurality of multiple contaminants simultaneously, for example, by performing multiple cycles of adjusting a pH to an optimal pH value and irradiating the contaminated water, until the water has been irradiated at an optimal pH value of each of the contaminants originally present in the water, as presented, for example, in FIGS. 5 and 6.

It is important to note that for each operation performed by the control unit in embodiments described herein, the operation may additionally or alternatively be performed manually according to some embodiments of the invention.

It is to be fully understood that the phrase ‘operatively connected’ is generally used herein, and equivalently refers to the corresponding synonymous phrases ‘operatively joined’, and ‘operatively attached’, where the operative connection, operative joint, or operative attachment, is according to a physical, or/and electrical, or/and electronic, or/and mechanical, or/and electro-mechanical, manner or nature, involving various types and kinds of hardware or/and software equipment and components. Additionally, it is to be fully understood that, unless specifically stated otherwise, the terms ‘connectable’, ‘connected’, and ‘connecting’, are generally used herein, and also may refer to the corresponding synonymous terms ‘joinable’, ‘joined’, and ‘joining’, as well as ‘attachable’, ‘attached’, and ‘attaching’.

Embodiments of the method and system of the present invention which are applicable for photodegrading multiple contaminants are implemented based on a variety of different spatial (i.e., physical, structural) and temporal (i.e., time dependent) configurations (modes) of order or sequence, and number, of the respective procedures and components thereof.

In an optional embodiment, a plurality of sources of contaminated water are treated in parallel, wherein for each source, a water contaminant and a corresponding optimal pH value are each identified, a pH is adjusted to the optimal value, and the water is irradiated, as described herein. Such an embodiment is applicable primarily when different sources are present with different contaminants in the different sources. A system according to such an embodiment optionally comprises a plurality of receiving units, pH adjustment units and photolytic reactor units, connected in parallel, so as to be suitable for treating separate sources of contaminated water in parallel.

In another optional embodiment, contaminated water is treated multiple times in series, wherein the contaminated water source passes through a plurality of cycles of adjustment of pH to an optimal value and irradiation, so as to irradiate the contaminated water at optimal pH values of a plurality of contaminants present therein. A system according to such an embodiment optionally comprises a plurality of input units, pH adjustment units and photolytic reactor units, connected in series, so as to be suitable for treating contaminated water with multiple cycles of pH adjustment and irradiation. Alternatively, or additionally, the output unit of the system is connected to the input unit of the system, such that after a first cycle of treatment, the water may be returned via the input unit for an additional cycle of treatment. In such an embodiment, a single pH adjustment unit and a single photolytic reactor unit may be sufficient for treating the contaminated water with any number of treatment cycles.

According to some embodiments of the invention, process controlling pH effects during practice of direct photodegradation is performed in a systematic, methodical, and phenomenological, optimal manner, way, or mode, for treating, remediating and/or purifying contaminated water, particularly, with respect to commercial applicability, practicality, and/or economical feasibility of implementation. This may be used, for example, for types of applications and scenarios wherein a contaminated water source originates from, and/or is associated with, industrial or commercial, governmental, or residential, facilities and/or infrastructure involved with collecting, processing, recycling, or/and disposing, of large quantities of contaminated water, where the contaminated water contains any number or combination of a wide variety of different types or kinds of contaminants which can be photodegraded.

In an exemplary embodiment of the invention, the water includes at least 3, 4, 5, 6, 7, 10, 20, 40 or more contaminants or contaminant families (e.g., materials that react in a similar manner to treatment). Optimization of the pH may be applied to each contaminant. Any contaminants having identical optimal pH values are treated simultaneously and do not require separate pH optimization.

According to an optional embodiment, contaminants having optimal pH values which are close to one another (e.g., differing by less than 0.5, differing by less than 0.25, etc.) but not identical are treated simultaneously at a single pH value (e.g., a pH value intermediate between the optimal pH for each contaminant). Optionally, a weighted optimization is used, for example, based on a toxicity level and/or concentration of the contaminants, for example, such that, an intermediate pH value used for two contaminants is closer to the optimal pH value of the contaminant with higher toxicity and/or concentration. Optionally, information such as toxicity levels (e.g., LD₅₀ values) for use in weighted optimization is stored in a database described herein.

It is to be understood that the present invention is not limited in its application to the details of the order or sequence, and number, of steps or procedures, and sub-steps or sub-procedures, of operation or implementation of the method, or to the details of type, composition, construction, arrangement, order, and number, of the system units, system sub-units, devices, assemblies, sub-assemblies, mechanisms, structures, components, elements, and configurations, and, peripheral equipment, utilities, accessories, chemical reagents, and materials, of the system, set forth in the following illustrative description, accompanying drawings, and examples, unless otherwise specifically stated herein.

Embodiments of the present invention are particularly advantageous for treating water contaminated with one or more organic compound(s).

Optionally the contaminant (e.g., organic compound) is a compound which is biologically active (e.g., a pharmaceutical compound, an antibiotic, an agrochemical, a pesticide).

As used herein, the phrase “biologically active” refers to having an effect (e.g., positive or negative effect on behavior, growth, health and/or viability) on living tissue and/or a biological organism, including an animal, a plant, a fungus, a single-celled organism, a bacterium and a virus.

Biologically active compounds may pose numerous environmental hazards (e.g., toxicity to humans and/or beneficial organisms, induction of resistance in harmful organisms, enhancement of growth of harmful organisms, etc.), and the ability of embodiments of the present invention to treat water contaminated by such compounds, as exemplified hereinbelow, is therefore particularly advantageous.

Although illustrative description of the present invention, in some embodiments thereof, is primarily focused on applications involving treatment of contaminated water wherein the organic chemical contaminants are the widely known and used (and potentially hazardous) biologically active organic compounds, it is to be fully understood that the present invention, in some embodiments thereof, is applicable a wide variety of contaminants of numerous types. Accordingly, the present invention can be practiced or implemented according to various other alternative embodiments and in various other alternative ways.

According to another aspect of embodiments of the present invention, there is provided a database listing a plurality of water contaminants and a corresponding plurality of optimal pH values for photodegradation of each of said water contaminants, as detailed herein.

The optimal pH values are optionally selected so as to be within a particular range of pH values and/or so as to represent an optimal pH value of photodegradation under particular conditions (e.g., ultraviolet radiation), as described herein.

According to a further aspect of embodiments of the present invention, there is provided a process for forming the abovementioned database, the process comprising determining a plurality of optimal pH values for a corresponding plurality of water contaminants, and storing the optimal pH values in the database. Determining optimal pH values can be performed as described hereinabove.

It is also to be understood that all technical and scientific words, terms, or/and phrases, used herein throughout the present disclosure have either the identical or similar meaning as commonly understood by one of ordinary skill in the art to which this invention belongs, unless otherwise specifically defined or stated herein. Phraseology, terminology, and, notation, employed herein throughout the present disclosure are for the purpose of description and should not be regarded as limiting.

Moreover, all technical and scientific words, terms, or/and phrases, introduced, defined, described, or/and exemplified, in the above Field and Background section, are equally or similarly applicable in the illustrative description of the preferred embodiments, examples, and appended claims, of the present invention. Immediately following are selected definitions and exemplary usages of words, terms, or/and phrases, which are used throughout the illustrative description of the preferred embodiments, examples, and appended claims, of the present invention, and are especially relevant for understanding thereof.

Each of the following terms: ‘includes’, ‘including’, ‘has’, ‘having’, ‘comprises’, and ‘comprising’, and, their derivatives and conjugates, means ‘including, but not limited to’.

Each of the following terms written in singular grammatical form: ‘a’, ‘an’, and ‘the’, may also refer to, and encompass, a plurality of the stated entity or object, unless otherwise specifically defined or stated herein, or, unless the context clearly dictates otherwise. For example, the phrases ‘a device’, ‘an assembly’, ‘a mechanism’, ‘a component’, and ‘an element’, may also refer to, and encompass, a plurality of devices, a plurality of assemblies, a plurality of mechanisms, a plurality of components, and a plurality of elements, respectively. For example, the phrase ‘a compound’ may also refer to, and encompass, a plurality of compounds, or/and mixtures thereof.

Throughout the illustrative description of the embodiments, the examples, and the appended claims, of the present invention, a numerical value of a parameter, feature, object, or dimension, may be stated or described in terms of a numerical range format. It is to be fully understood that the stated numerical range format is provided for illustrating implementation of the present invention, and is not to be understood or construed as inflexibly limiting the scope of the present invention.

Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Steps or procedures, sub-steps or sub-procedures, and, equipment and materials, system units, system sub-units, devices, assemblies, sub-assemblies, mechanisms, structures, components, elements, and configurations, and, peripheral equipment, utilities, accessories, chemical reagents, and materials, as well as operation and implementation, of exemplary preferred embodiments, alternative preferred embodiments, specific configurations, and, additional and optional aspects, characteristics, or features, thereof, of the method and system for treating contaminated water via pH optimized photodegradation, according to the present invention, in some embodiments thereof, are better understood with reference to the following illustrative description and accompanying drawings. Throughout the following illustrative description and accompanying drawings, same reference notation and terminology (i.e., numbers, letters, or/and symbols), refer to same system units, system sub-units, devices, assemblies, sub-assemblies, mechanisms, structures, components, elements, and configurations, and, peripheral equipment, utilities, chemical reagents, accessories, and materials, components, elements, or/and parameters.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Selected embodiments of the present invention, including novel and inventive aspects, characteristics, special technical features, and advantages thereof, as illustratively described hereinabove, and as claimed in the claims section hereinbelow, are exemplified and have experimental support in the following examples, which are not intended to be limiting.

### Materials and Methods

Amoxicillin, ampicillin, carbamazepine, ciprofloxacin, enrofloxacin, norfloxacin, oxytetracycline, pyriproxyfen, sulfamethoxazole, tetracycline and trimethoprim were obtained from Sigma-Aldrich.

Solutions of tested contaminants were prepared by dissolving one or more contaminant in 150 ml deionized water (DI) at a concentration of 1 mg/l for each contaminant. The solution was then placed into an open 90×50 mm crystallization dish.

The aqueous solution was stirred continuously for the duration of the experiment, and irradiated using a 0.45 kW polychromatic medium-pressure (MP) Hg vapor lamp (Ace-Hanovia Lamp Cat. No. 7830-61, from Ace Glass Inc.) housed in a bench scale collimated beam apparatus. The polychromatic irradiation was at ultraviolet (UV) wavelengths in a range of 200-400 nm.

0.5 ml samples were removed from the irradiated solution at selected time intervals in order to measure the concentration of the remaining contaminant. Samples were measured in a 1100-Finnigan LCQ HPLC/MS/MS (high performance liquid chromatography/tandem mass spectrometry) apparatus (Agilent), in order to obtain a chromatogram for the sample. The concentration was expressed as the area of the peak observed in the HPLC/MS/MS chromatogram.

The degradation kinetics were expressed as a logarithm of the ratio of the concentration (C_{H}) remaining following a dose H of irradiation to initial concentration (C₀). Such a logarithm decreased in a linear manner as a function of the dose, as follows:

$$ln \frac{{C}_{H}}{{C}_{0}} = - k H$$

H is the UV dose and was calculated as average fluence rate (mW/cm²) multiplied by irradiation time (seconds), and can be expressed in units of mJ/cm².

The data were fitted using a linear regression approach (with R²>0.9) resulting in pseudo-first order reaction kinetics which reflect the difference in photodegradation between samples. The constant k (cm²/mJ), the degradation rate fluence-based constant, was calculated as the negative slope obtained when the degradation was plotted logarithmically as described hereinabove.

The UV dose required for 90% degradation of the tested contaminants was calculated using the obtained value for k, by inserting the appropriate numbers into the above equation:

$$ln \frac{[ 10 \% ]}{[ 100 \% ]} = - 2.3 = - k H$$

### Example 1

### Direct Photolytic Degradation of Sulfamethoxazole (SMX) and Sulfadimethoxine (SMT)

Direct photolytic degradations of the exemplary 1-sulfonamide antibiotics sulfamethoxazole (SMX) and sulfadimethoxine (SMT) were studied separately in deionized (DI) water.

Sulfamethoxazole (SMX) and sulfadimethoxine (SMT), two sulfonamide antibiotics, are commonly used in human and veterinary medicine in food-producing animals as growth promoters and as therapeutic and prophylactic drugs for a variety of bacterial and protozoan infections [39].

As shown in FIG. 4, there was considerable overlap between the absorption spectra of SMX and SMT and the emission spectrum of the UV MP lamp used for irradiation.

The photolytic degradation of each of SMX and SMT were measured at pH values of 5, 6 and 7.

As shown in FIG. 7, the photolytic degradation of SMX was more rapid at a pH of 5 than at a pH of 7. Thus, 90% degradation of SMX occurred at pH 5 at a UV dose of less than 300 mJ/cm² (approximately 4 minutes), whereas 90% degradation at pH 7 was achieved only following a UV dose of more than 1000 mJ/cm² (approximately 12 minutes).

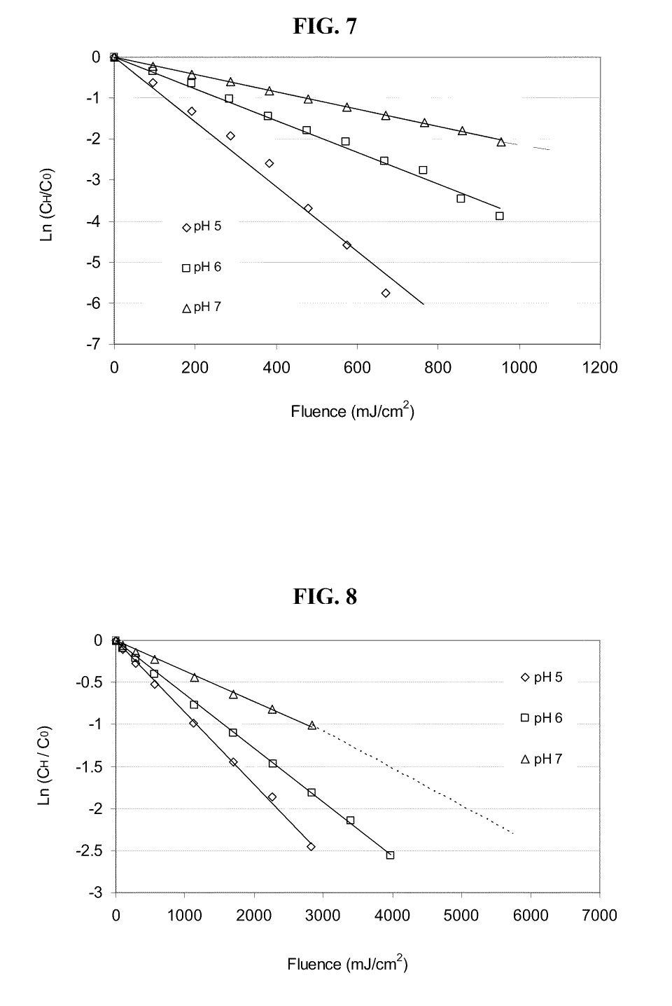

As shown in FIG. 8, the photolytic degradation of SMT was more rapid at a pH of 5 than at a pH of 7.

As shown in FIG. 9, SMX comprises an acidic nitrogen atom with a pKa of 5.7, such that the nitrogen atom is protonated at a pH lower than 5.7 and ionic at a pH above 5.7. SMT has a similar structure, with a pKa of 6.08. Thus, the above results suggest that the protonated form of SMX and SMT undergoes photodegradation more rapidly than the ionic form.

As can be seen by comparing FIGS. 7 and 8, degradation of SMX was considerably more rapid than degradation of SMT. The difference in the photodegradation rate between the two antibiotics may be due to differences in absorption spectrum and quantum yield.

Table 1 presents the UV doses required for 90% photodegradation of SMX and SMT at the tested pH levels. The difference between the UV dose required for 90% degradation at the least favorable tested pH value and the UV dose required for 90% degradation at the optimal pH value is presented therein as the “reduction in UV dose”.

TABLE 1
UV dose required to achieve 90% photodegradation
of SMX and SMT in deionized water

| | | | UV dose for 90% | | | Reduction |
|---|---|---|---|---|---|---|
| Com- | | Relevant | degradation (mJ/cm²) | | | in UV |
| pound | Family | pKa (5-8) | pH 5 | pH 6 | pH 7 | dose (%) |
| SMX | Antibiotics- | 5.7 | 291 | 590 | 1095 | 73.4 |
| SMT | Sulfonamides | 6.08 | 2400 | 3300 | 5750 | 58.3 |

The effect of different pH values on the SMX degradation rate was also tested in synthetic wastewater (synthetic effluent water), representing biologically treated sewage effluent. Synthetic wastewater was prepared as described in Seo et al. [40] and diluted with deionized water to obtain a 70% transmittance at 254 nm, which is typical for wastewater effluents treated by UV irradiation. Characteristics of the diluted synthetic waste water effluent used in this study are presented in Table 2.

TABLE 2
Diluted synthetic wastewater properties

| | TOC | Alk | COD | TDS | Ca⁺² | Cl⁻ | NO⁻ | PO₄⁻³ | Fe⁺² | HCO₃⁻ | SO₄⁻² |
|---|---|---|---|---|---|---|---|---|---|---|---|
| pH | mg/l | | | | | | | | | | |
| 6.4 | 1.25 | 5 | 26 | 215 | 0.4 | 1.9 | <1 | 1.2 | 0.035 | 6.1 | <5 |

TOC = Total Organic Carbon (mg/l carbon)
Alk = Alkalinity (mg/l CaCO₃ acid neutralizing capacity)
COD = Chemical Oxygen Demand (mg/l oxygen required to oxidize organic compounds to CO₂ and ammonia to nitrate)
TDS = Total Dissolved Solids

As shown in FIG. 10, the photolytic degradation of SMX in synthetic effluent water was more rapid at a pH of 5 than at a pH of 7.

Table 3 below presents the UV doses needed to achieve 90% photodegradation of SMX in synthetic effluent, at different pH values.

Thus, as observed in DI water, lowering the pH of the UV treated effluent from pH 7 to pH 5, results in a significant increase in the degradation rate. Moreover, the reduction in the UV dose required for 90% degradation in synthetic effluent (80.8%) was similar to the reduction in DI water (73.4%).

As shown in Tables 2 and 3, degradation rates of SMX in synthetic effluent are lower than those observed for DI water.

TABLE 3
UV dose required to achieve 90% photodegradation
of SMX in synthetic effluent water

| | | | UV dose for 90% | | | Reduction |
|---|---|---|---|---|---|---|
| Com- | | Relevant | degradation (mJ/cm²) | | | in UV |
| pound | Family | pKa | pH 5 | pH 6 | pH 7 | dose (%) |
| SMX | antibiotics- | 5.7 | 315 | 639 | 1643 | 80.8 |
| | sulfonamides | | | | | |

### Example 2

### Direct Photolytic Degradation of Tetracycline (TC), Oxytetracycline (OTC), Amoxicillin (AMX), Ampicillin (AMP), Ciprofloxacin (CPR), Enrofloxacin (ENR), Norfloxacin (NOR), Trimethoprim (TMP) and Carbamazepine (CPZ)

Direct photolytic degradations of exemplary pharmaceuticals were studied separately in deionized (DI) water.

Tetracycline (TC) and oxytetracycline (OTC) are tetracycline antibiotics, used mainly in veterinary medicine and in animal feeds to maintain health and improve growth efficiency [39, 41]. Amoxicillin (AMX) and ampicillin (AMP) are examples of β-lactam antibiotics, the most widely used group of antibiotics available, used mainly for the prophylaxis and treatment of bacterial infections. Ciprofloxacin (CPR), enrofloxacin (ENR) and norfloxacin are fluoroquinolone antibiotics, a group of relatively new, entirely man-made, non-steroidal antibiotics/antibacterials, which have proved to exhibit highly valuable antimicrobial and pharmacokinetic properties in human as well as in veterinary medicine [42]. Trimethoprim (TMP) is a dihydrofolate reductase inhibitor, used mainly in the treatment of bacterial infections of the urinary tract, lungs and airways. Carbamazepine (CPZ) is an antiepileptic drug whose occurrence in municipal STP effluents and in domestic wastewaters has been reported in the literature [5].

The above nine pharmaceutical compounds, from five different classes, were irradiated separately under conditions similar to those described in Example 1.

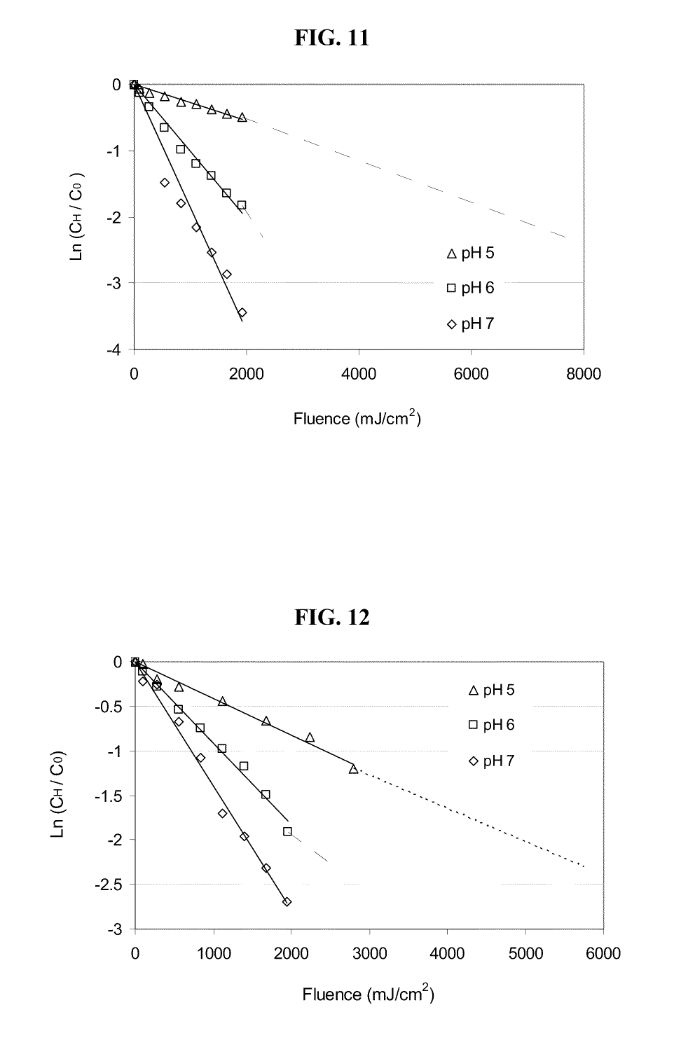

The degradation kinetics of each of the compounds are presented in FIGS. 11-19. The UV doses needed to achieve 90% degradation at different pH values for each of the tested compounds, as well as their relevant pKa values of the compounds, are presented in Table 4.

TABLE 4
UV doses required to achieve 90% degradation
of various pharmaceuticals in deionized water

| | | | UV dose for 90% | | | | Reduction |
|---|---|---|---|---|---|---|---|
| Com- | | Relevant | degradation (mJ/cm2) | | | | in UV |
| pound | Family | pKa | pH 5 | pH 6 | pH 7 | pH 8 | dose (%) |
| TC | antibiotics- | 4.5, 7.3 | 8000 | 2300 | 1200 | — | 85.0 |
| OTC | tetracyclines | 4.5, 7.3 | 5750 | 2556 | 1643 | — | 71.4 |
| AMX | antibiotics- | 6.9 | — | 3285 | 2090 | 2090 | 36.4 |
| AMP | β-lactams | 6.9 | — | 2875 | 2875 | 1916 | 33.4 |
| CPR | antibiotics- | 6.03 | 2091 | 742 | 403 | — | 80.7 |
| ENR | fluoroquinolone | 5.94 | 3286 | 2300 | 1045 | — | 68.2 |
| NOR | | 8.4 | 4600 | 2091 | 697 | — | 84.7 |
| TMP | dihydrofolate | 7 | — | 23000 | 3833 | 1770 | 95.4 |
| | reductase | | | | | | |
| | inhibitor | | | | | | |
| CPZ | antiepileptic | 13 | — | 23000 | 11500 | 7667 | 66.6 |

As shown in FIG. 11 and in Table 4, the photolytic degradation of TC was more rapid at a pH of 7 than at a pH of 5.

As shown in FIG. 12 and in Table 4, the photolytic degradation of OTC was more rapid at a pH of 7 than at a pH of 5.

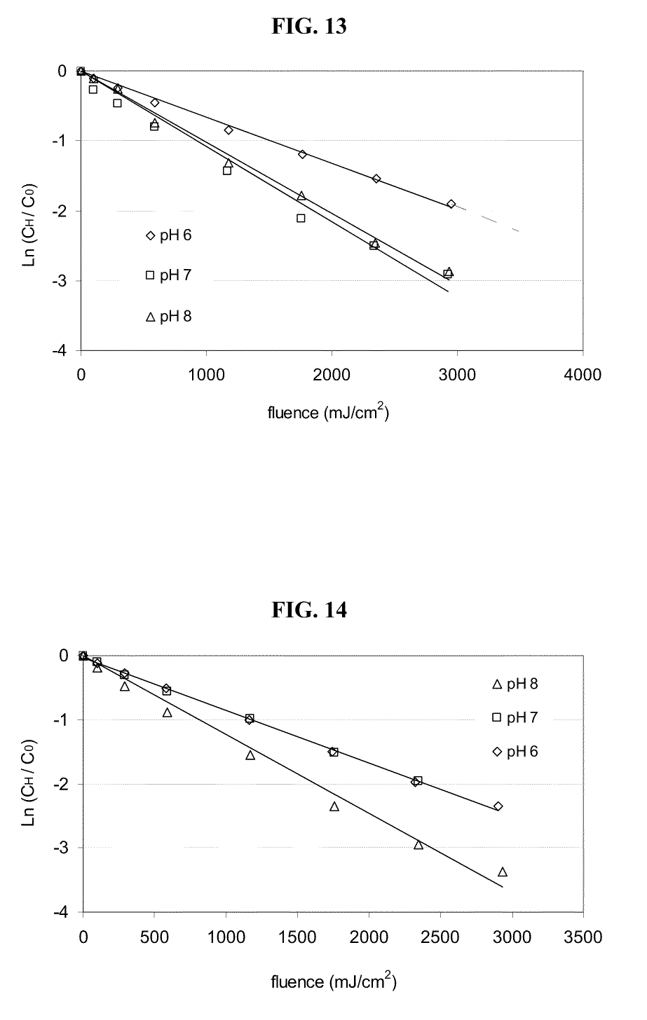

As shown in FIG. 13 and in Table 4, the photolytic degradation of AMX was more rapid at a pH of 7 or 8 than at a pH of 6.

As shown in FIG. 14 and in Table 4, the photolytic degradation of AMP was more rapid at a pH of 8 than at a pH of 7 or 6.

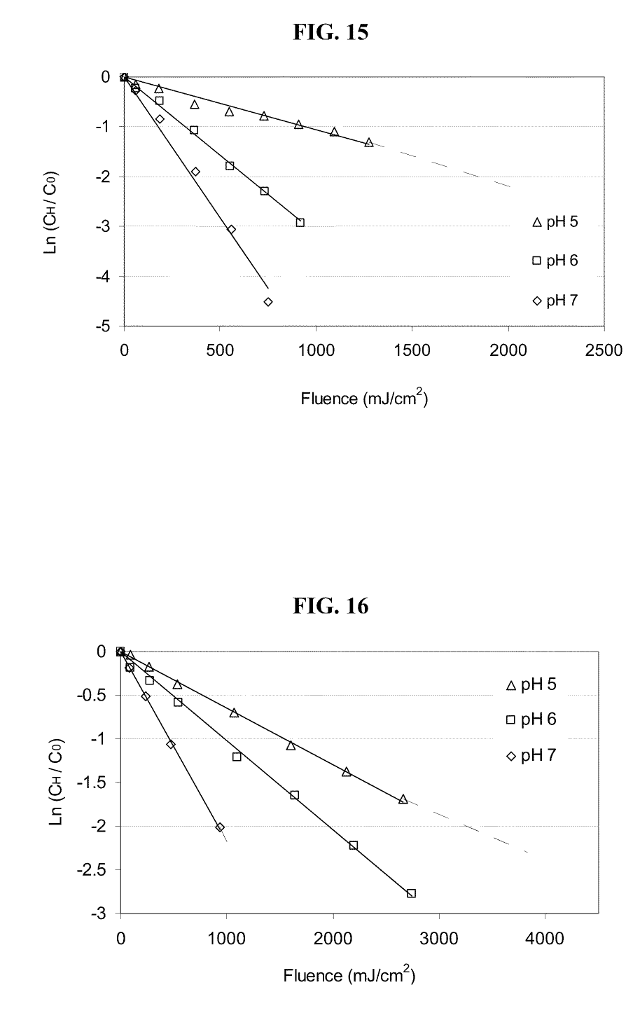

As shown in FIG. 15 and in Table 4, the photolytic degradation of CPR was more rapid at a pH of 7 than at a pH of 5.

As shown in FIG. 16 and in Table 4, the photolytic degradation of ENR was more rapid at a pH of 7 than at a pH of 5.

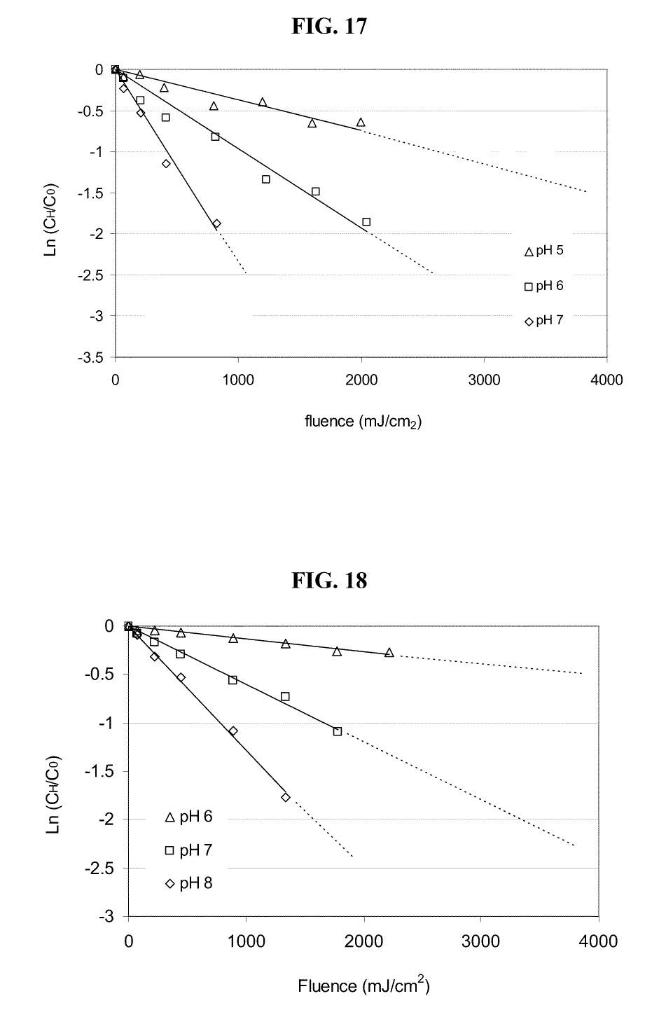

As shown in FIG. 17 and in Table 4, the photolytic degradation of NOR was more rapid at a pH of 7 than at a pH of 5.

As shown in FIG. 18 and in Table 4, the photolytic degradation of TMP was more rapid at a pH of 8 than at a pH of 6.

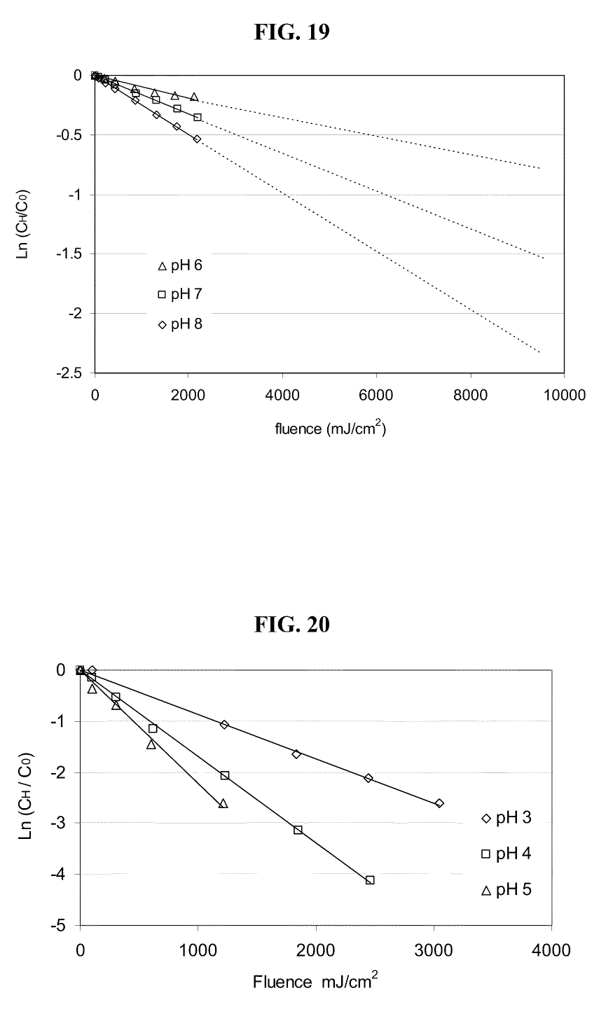

As shown in FIG. 19 and in Table 4, the photolytic degradation of CPZ was more rapid at a pH of 8 than at a pH of 6.

As shown in FIG. 20 and in Table 4, the photolytic degradation of PRX was more rapid at a pH of 5 than at a pH of 3.

Photolysis rate of all the above compounds showed a high pH dependency, however, while SMX and SMT (Example 1) degraded most rapidly at low pH values (5), direct photodegradation of other classes of antibiotics were higher at high levels of pH (7-8).

The reduction in UV dose required for 90% degradation was as high as 95% (for TMP). Thus, changing the pH value from 6 to 8 enhanced the photolysis rate of TMP by more than 12-fold.

### Example 3

### Direct Photolytic Degradation of the Pesticide Pyriproxyfen (PRX)

Direct photolytic degradation of the exemplary pesticide pyriproxyfen (PRX) was studied in deionized (DI) water.

The PRX solution was irradiated as described in Example 1.

Pyriproxyfen is a chiral class, juvenile hormone mimicking insecticide, used for control of flies, beetles, midges and mosquitoes in public health applications. It is also used in agriculture in some countries, including the USA.

The photodegradation of PRX was tested at relatively low pH values (3-5) due to the low pKa value of 3.6 exhibited by PRX. The results are shown in FIG. 20 and in Table 5 below.

TABLE 5
UV dose required to achieve 90% degradation of PRX

| | | | UV dose for 90% | | | Reduction |
|---|---|---|---|---|---|---|
| com- | | Relevant | removal (mJ/cm²) | | | in UV |
| pound | Family | pKa | pH 3 | pH 4 | pH 5 | dose (%) |
| PRX | Pesticide | 3.6 | 2555.6 | 1352.9 | 1277.8 | 50 |

As shown in FIG. 20 and in Table 5, the photolytic degradation of PRX was more rapid at a pH of 5 than at a pH of 3.

Photodegradation of PRX resulted in the formation of a yet unidentified byproduct, detected by the HPLC-MS/MS. One of the future goals of our work is to be able to determine main photolysis intermediates, their toxicity, and their effect on the degradation kinetics of the parent compound.

### Example 4

### Direct Photolytic Degradation in a Mixture of Sulfamethoxazole (SMX), Oxytetracycline (OTC) and Ciprofloxacin (CPR)

Direct photolytic degradation of the exemplary antibiotics sulfamethoxazole (SMX), oxytetracycline (OTC) and ciprofloxacin (CPR) was studied in a deionized (DI) water solution containing all three antibiotics. Direct (UV) photodegradation of SMX, OTC and CPR in separate aqueous solutions is described in Examples 1 and 2.

The mixture of SMX, OTC and CPR was irradiated as described in Example 1.

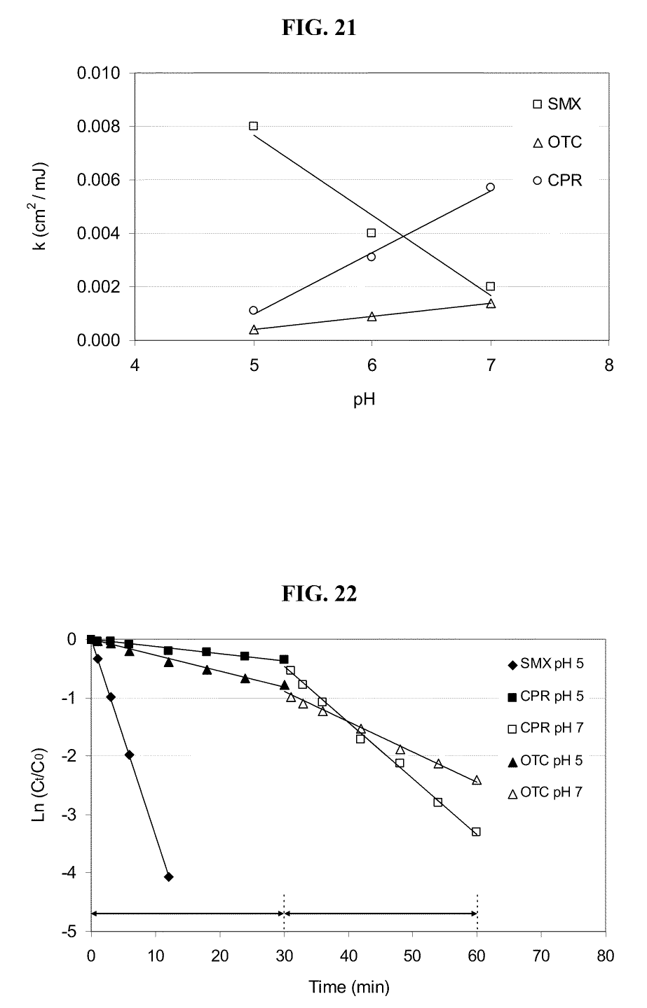

The rate constants (k) for photolytic degradation of the three compounds, as obtained from the results of Examples 1 and 2, are shown in FIG. 21. As shown in FIG. 21, the rate constant for SMX is higher at a pH of 5 than at a pH of 7, whereas the rate constant for photolytic degradation for OTC and CPR is higher at a pH of 7 than at a pH of 5.

Due to differences in optimal pH values for photodegradation of SMX, OTC and CPR, the photodegradation of an aqueous solution of all three compounds was performed using irradiation at pH 5 for a 30 minutes period in order to maximize degradation of SMX, followed by altering the pH to a value of 7 and irradiation pH 7 for an additional 30 minutes in order to maximize degradation of OTC and CPR.

As shown in FIG. 22, the irradiation at pH 5 resulted in a considerable degradation (98.4%) of SMX, while the irradiation at pH 7 significantly enhanced degradation of OTC and CPR. Thus, only OTC was degraded by only 54%, and CPR by only 26% by irradiation at pH 5, but degradation of OTC and CRP were increased to 91% and 96% respectively after irradiation at pH 7. By extrapolation, it was calculated that without the change of pH change, OTC would have been degraded by only 81%, and CIP by only 53%, by 60 minutes of UV irradiation at pH 5.

These results indicate that altering the pH of a solution with more than one contaminant during UV irradiation can significantly improve photodegradation of the contaminants therein.

### Example 5

### Direct Photolytic Degradation in a Mixture of Sulfadimethoxine (SMT), Tetracycline (TC), Amoxicillin (AMX), Norfloxacin (NOR) and Trimethoprim (TMP)

Direct photolytic degradation of the exemplary pharmaceuticals sulfadimethoxine (SMT), tetracycline (TC), amoxicillin (AMX), norfloxacin (NOR) and trimethoprim (TMP) is performed for an aqueous effluent containing all five compounds as contaminants. Direct (UV) photodegradation of SMT, TC, AMX, NOR and TMP in separate aqueous solutions is described in Examples 1 and 2.

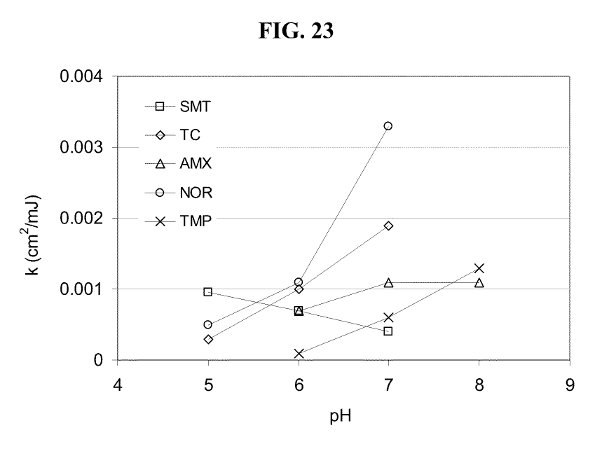

The rate constants (k) for photolytic degradation of the five compounds, as obtained from the results of Examples 1 and 2, are shown in FIG. 23. As shown in FIG. 23, the rate constant for SMT is higher at a relatively low pH (pH 5), whereas the rate constant for photolytic degradation for TC, AMX, NOR and TMP is higher at a relatively high pH (pH 7 or 8).

Based on the abovementioned data, the pharmaceuticals are classified into two groups of contaminants, contaminants for which an optimal pH for photodegradation is 5, and contaminants for which an optimal pH for photodegradation is 7 or 8.

pH-optimized photolytic treatment of water contaminated with the abovementioned pharmaceuticals is performed by either of the following methods:
(1) Separate treatment of different source streams, in a scenario where contaminants from different groups (as characterized by optimal photodegradation pH values) are not combined in a single source stream. A pH value of each one of the treated streams (containing one contaminant or a plurality of contaminants with similar optimal pH values) is modified to its optimal value (for TC, AMX, NOR and TMP, pH 7-8; for SMT, pH 5) and passed through a different MP UV reactor (or the same reactor but at different times for each stream).

The treated streams are joined together after the UV reactors, as illustrated in FIG. 5, a schematic diagram illustrating a ‘parallel’ type optional embodiment of a system for treating contaminated water via pH optimized direct photolysis, based on the embodiment of the system illustrated in FIG. 2, wherein two separate contaminated water external sources, each containing a different water contaminant group, are treated in parallel according to a ‘parallel’ configuration (mode) of implementation of the method steps and system units of embodiments of the present invention.
(2) Sequential pH optimization UV treatment which includes several steps: pH modification of the solution containing the five contaminants to optimize the degradation of one of the abovementioned group of contaminants (as characterized by optimal photodegradation pH values), UV irradiation of the water, a second pH modification to optimize the degradation of the other one of the abovementioned group of contaminants, and a second exposure to UV radiation, as illustrated in FIG. 6.

The same stream will be treated ‘in series’, as illustrated in FIG. 6, a schematic diagram illustrating a ‘series’ type optional embodiment of a system for treating contaminated water via pH optimized direct photolysis, based on the embodiment of the system illustrated in FIG. 2, wherein a single contaminated water external source containing two different water contaminant groups is treated in series according to a ‘series’ configuration (mode) of implementation of the method steps and system units of embodiments of the present invention.

It is to be fully understood that certain aspects, characteristics, and features, of the invention, which are illustratively described and presented in the context or format of a plurality of separate embodiments, may also be illustratively described and presented in any suitable combination or sub-combination in the context or format of a single embodiment. Conversely, various aspects, characteristics, and features, of the invention, which are illustratively described and presented in combination or sub-combination in the context or format of a single embodiment, may also be illustratively described and presented in the context or format of a plurality of separate embodiments.

Although the invention has been illustratively described and presented by way of preferred and specific embodiments, and examples thereof, it is evident that many alternatives, modifications, and variations, thereof, will be apparent to those skilled in the art. Accordingly, it is intended that all such alternatives, modifications, and variations, fall within, and are encompassed by, the scope of the appended claims.

All patents, patent applications, and publications, cited or referred to in this specification are herein incorporated in their entirety by reference into the specification, to the same extent as if each individual patent, patent application, or publication, was specifically and individually indicated to be incorporated herein by reference. In addition, citation or identification of any reference in this specification shall not be construed or understood as an admission that such reference represents or corresponds to prior art of the present invention.

### REFERENCES

1. Chemosphere, 36: 357-393 (1998), “Occurrence, Fate And Effects Of Pharmaceutical Substances In The Environment—A Review”, Halling-Sørensen, B., Nors Nielsen, S., Lanzky, P. F., Ingerslev, F., Holten Lützhøft, H. C., and Jorgensen, S. E.
2. J. Chromatogr. A, 1021: 133-144 (2006), “Determination Of Acidic Pharmaceuticals, Antibiotics And Ivermectin In River Sediment Using Liquid Chromatography—tandem Mass Spectrometry”, Löffler, D., Ternes, T. A.
3. J. Chromatogr. A, 1015: 129-141 (2003), “Determination Of Selected Human Pharmaceutical Compounds In Effluent And Surface Water Samples By High-performance Liquid Chromatography—electrospray Tandem Mass Spectrometry”, Hilton, M. J. and Thomas, K. V.
4. Chemosphere, 64: 1963-1971 (2006), “Occurrence Of Sulfonamide Antimicrobials In Private Water Wells In Washington County, Idaho, USA”, Batt, A. L., Snow, D. D. and Aga, D. S.
5. J. Chromatogr. A, 911: 225-234 (2001), “Simultaneous Quantification Of Neutral And Acidic Pharmaceuticals And Pesticides At The Low-ng/l Level In Surface And Waste Water”, 011ers, S., Heinz, P. S., Fassler, P., and Muller, S. R.
6. Chemosphere, 50: 1319-1330 (2003), “Pharmaceuticals In STP Effluents And Their Solar Photodegradation In Aquatic Environment”, Andreozzi, R., Raffaele, M., and Nicklas, P.
7. City of Ann Arbor, Water Utilities Fleis & VandenBrink Engineering, Inc. (2004), “The Occurrence And Fate Of Pharmaceuticals, Personal Care Products And Endocrine Disrupting Compounds In A Municipal Water Use Cycle: A Case Study In The City Of Ann Arbor”, Skadsen, J. M., Rice, B. L., and Meyering, D. J.
8. “The Environmental Science Of Drinking Water”, 1st ed., Elsevier (2005), Sullivan P. J., Agardy, F. J., and Clark, J. J. J.
9. J. Environ. Eng., 128: 253-260 (2002), “Removal Of Antibiotics From Surface And Distilled Water In Conventional Water Treatment Processes”, Adams, C., Wang, Y., Loftin, K., and Meyer, M.
10. ‘Wikipedia®, The Free Encyclopedia’, web page address: http://en.wikipedia.org/wiki/Photodegradation, last modified on Aug. 15, 2009, as accessed according to the search word and GO of ‘photodegradation’, and viewed on Sep. 1, 2009.
11. International Union of Pure And Applied Chemistry (IUPAC), 1996, Glossary of terms used in photochemistry (IUPAC Recommendations 1996): Pure and Applied Chemistry, v. 68, no. 12, p. 2223-2286.
12. “Chemical Oxidation, Water Quality and Treatment: A Handbook of Community Water Supplies”, McGraw-Hill, Inc., New York (1999), Singer, P., and Reckhow, D.
13. ‘Wikipedia®, The Free Encyclopedia’, web page address: http://en.wikipedia.org/wiki/Advanced_Oxidation_Process, last modified on Sep. 1, 2008, as accessed according to the search word and GO of ‘advanced oxidation process’, and viewed on Sep. 2, 2008.
14. U.S. Pat. No. 6,409,928, to Gonzalez, et al., entitled: “Photocatalytic Oxidation Of Organics Using A Porous Titanium Dioxide Membrane And An Efficient Oxidant”.
15. U.S. Pat. No. 5,124,051, to Bircher, et al., entitled: “Process For Treatment Of Contaminated Waste Water Or Groundwater”.
16. U.S. Pat. No. 5,919,982, to Whittaker, et al., entitled: “Process And Apparatus For The Removal Of Aromatic Amines From Soil And Water”.
17. WIPO PCT Pat. Appl. Int'l. Pub. No. WO 2000/06498, published Feb. 10, 2000, of PCT Pat. Appl. No. PCT/EP99/05225, filed Jul. 22, 1999, entitled: “Method And Device For Processing Aqueous Liquids Containing Cyanide”.
18. KR Pat. Appl. Pub. No. KR 2003-0008074, published Jan. 24, 2003, filed, Jul. 16, 2001, entitled: “Method For Treating Wastewater From Desulfurization Facilities Using Photo Fenton Oxidation Process”.
19. U.S. Pat. No. 5,424,032, to Christensen, et al., entitled: “Method And Apparatus For Controlling Microorganisms”.
20. U.S. Pat. No. 5,234,606, to Kazama, et al., entitled: “Method And System For Recovering Wastewater”.
21. U.S. Pat. No. 5,582,741, to Kenmoku, et al., entitled: “Method For Treating Polluted Water”.
22. U.S. Pat. No. 6,200,466, to Bender, entitled: “Decontamination Of Water By Photolytic Oxidation/reduction Utilizing Near Blackbody Radiation”.
23. U.S. Pat. No. 7,270,728, to Guo, et al., entitled: “Photochemical Transformation Of Metallic And Non-metallic Ions In An Aqueous Environment”.
24. U.S. Pat. No. 6,610,178, to Kato, et al., entitled: “Method For Decomposing Halogenated Aliphatic Hydrocarbon Compounds Or Aromatic Compounds, Method For Cleaning Medium Contaminated With At Least One Of These Compounds, And Apparatus For These”.
25. U.S. Pat. No. 6,616,815, to Kato, et al., entitled: “Method Of Decomposing Halogenated Aliphatic Hydrocarbon Compounds Or Aromatic Compounds And Apparatus To Be Used For The Same As Well As Method Of Clarifying Exhaust Gas And Apparatus To Be Used For The Same”.
26. U.S. Pat. No. 5,043,080, to Cater, et al., entitled: “Treating Contaminated Effluents And Groundwaters”.
27. U.S. Pat. No. 5,470,480, to Gray, et al., entitled: “Process For Treating Waste Water Effluent”.
28. U.S. Pat. No. 3,951,797, to Seely, entitled: “Photooxidative Destruction Of Organic Wastes”.
29. U.S. Pat. No. 4,176,026, to Harriman, et al., entitled: “Process For Catalytic Photo-oxidation Of Water”.
30. U.S. Pat. No. 3,951,797, to Betermier, et al., entitled: “Destruction Of Iron Cyanide Complexes”.
31. Chemosphere, 63: 269-276 (2006), “Degradation Of The Pharmaceutical Metronidazole Via UV, Fenton And Photo-Fenton Processes”, Shemer, H., Kac, Y., Kunukcu, A., and Linden, K. G.
32. Water, Air, Soil Pollut., 168: 145-155 (2005), “Photodegradation of 3,5,6-Trichloro-2-Pyridinol (TCP) In Aqueous Solution”, Shemer, H., Sharpless, M. C., and Linden, K. G.
33. Water Res., 31, 2705-2710 (1997), “Biodegradability Of The Antitumour Agent Ifosfamide And Its Occurrence In Hospital Effluents And Communal Sewage”, Kummerer, K., Hartmann, T. S., and Meyer, M.
34. ASCE J. Environ. Eng., 132(12): 1554-1561 (2006), “Comparative Inactivation Of Bacillus Subtilis Spores And MS2 Phage In Model Low Pressure UV Reactor”, Bohrerova, Z., Mamane, H., Ducoste, J. J., and Linden, K. G.
35. J. Agric. Food Chem., 55: 4059-4065 (2007), “Photodegradation Of Metolachlor Applying UV And UV/H₂O₂, Wu, C., Shemer, H., and Linden, K. G.
36. Ozone Sci. Eng., 29: 273-280 (2007), “UV/H₂O₂ Treatment: A Practical Solution For Organic Contaminant Control And Primary Disinfection”, Kruithof, J. C., Kamp, P. C., and Bram, J. M.
37. USEPA Ultraviolet Disinfection Guidance Manual (2006), Office of Water (4601), EPA 815-R-06-007, November, 2006.
38. ASCE J. Env. Eng., 129(3): 209-215 (2003), “Standardization Of Methods For Fluence (UV dose) Determination In Bench-scale UV Experiments”, Bolton, J. R. and Linden, K. G.
39. Woodhead Publishing Limited, Abington, Cambridge, England (1991), “Determination Of Veterinary Residues In Food”, Crosby, N. T.
40. Water Sci. Technol., 35: 163-170 (1997), “Sorption Characteristics Of Biological Powdered Activated Carbon In BPAC-MF (biological activated carbon-microfiltration) System For Refractory Organic Removal”, Seo, G. T., Ohgaki, S., and Suzuki, Y.
41. Environ. Sci. Technol., 40 (23): 7222-7227 (2006), “Oxidation Of Sulfonamide Antimicrobials By Ferrate(VI) [FeVIO₄²⁻]”, Sharma, V. K., Mishra, S. K., and Nesnas, N.
42. Antimicrob. Agents. Chemother., 41: 2037-2040 (1997), “Comparative Susceptibilities Of Various Animal-pathogenic Mycoplasmas To Fluoroquinolones”, Hannan, P. C. T., Windsor, G. D., de Jong, A., Schmeer, N., and Stegemann, M.

1-41. (canceled)

42. A method for treating contaminated water, the method comprising:
(a) identifying a target water contaminant in the contaminated water;
(b) identifying an optimal pH value for photodegradation of said identified target water contaminant;
(c) adjusting a pH of the contaminated water to said optimal pH value of said identified target water contaminant, for forming pH-adjusted contaminated water at said optimal pH value; and
(d) subjecting said pH-adjusted contaminated water to irradiation selected capable of causing photodegradation of said identified target water contaminant, such that a concentration of said target water contaminant is reduced,
thereby treating said contaminated water.

43. The method of claim 42, wherein identifying said optimal pH value for photodegradation of said identified target water contaminant is performed using a database listing a plurality of target water contaminants and a corresponding plurality of optimal pH values for photodegradation of each of said target water contaminants.

44. The method of claim 42, further comprising, subsequent to identifying said target water contaminant, providing a database listing a plurality of target water contaminants and a corresponding plurality of optimal pH values for photodegradation of said target water contaminants.

45. The method of claim 42, wherein said irradiation comprises ultraviolet irradiation.

46. The method of claim 45, wherein said photodegradation is direct photodegradation.

47. The method of claim 42, wherein adjusting said pH of said contaminated water comprises adjusting said pH to a value in a range of 4 to 9.

48. The method of claim 42, wherein said contaminated water comprises a plurality of target water contaminants, the method comprising performing said (a)-(d) procedures for each of said target water contaminants.

49. The method of claim 42, wherein said target water contaminant is an organic compound.

50. The method of claim 49, wherein said organic compound is biologically active.

51. The method of claim 50, wherein said biologically active organic compound is selected from the group consisting of a pharmaceutical compound and an agrochemical.

52. A system for treating contaminated water, the system comprising:
a receiving unit, suitable for receiving and/or transporting the contaminated water;
a contaminant identification unit for identifying a contaminant in the contaminated water, being in communication with said receiving unit;
a pH adjustment unit operatively connected to said receiving unit, suitable for adjusting a pH of the contaminated water to an optimal pH value for photodegradation of an identified water contaminant in said contaminated water, to thereby form pH-adjusted contaminated water at said optimal pH value;
a photolytic reactor unit operatively connected to said pH adjustment unit, for subjecting said pH-adjusted contaminated water to photodegradation of said identified water contaminant by irradiation, so as to reduce a concentration of said identified water contaminant, to thereby obtain treated water; and
an output unit operatively connected to said photolytic reactor unit, suitable for containing and/or transporting said treated water.

53. The system of claim 52, further comprising a computerized database listing a plurality of water contaminants and a corresponding plurality of optimal pH values for photodegradation of said water contaminants, said computerized database being communicated with said contaminant identification unit.

54. The system of claim 53, further comprising a control unit, being communicated with said computerized database and said contaminant identification unit, and configured for using said database for identifying said optimal pH value for said identified water contaminant.

55. The system of claim 54, wherein said control unit is further communicated to said receiving unit, to said pH adjusting unit, to said photodegradation unit and/or to said output unit.

56. The system of claim 52, wherein said irradiation comprises ultraviolet irradiation.

57. The system of claim 56, wherein said photodegradation is direct photodegradation.

58. The system of claim 52, wherein said adjusting a pH of said contaminated water comprises adjusting said pH to a value in a range of 4 to 9.

59. The system of claim 52, wherein said target water contaminant is an organic compound.

60. The system of claim 59, wherein said organic compound is biologically active.

61. The system of claim 60, wherein said biologically active organic compound is selected from the group consisting of a pharmaceutical compound and an agrochemical.

62. The system of claim 52, wherein said control unit is configured for treating a plurality of multiple contaminants simultaneously.

63. A database listing a plurality of water contaminants and a corresponding plurality of optimal pH values for photodegradation of each said water contaminants.

64. A process for forming the database of claim 63, the process comprising determining a plurality of optimal pH values for a corresponding plurality of water contaminants, and entering said optimal pH values and said water contaminants in the memory of a database.

65. The process of claim 64, wherein said photodegradation comprises ultraviolet irradiation.

66. The process of claim 65, wherein said photodegradation is direct photodegradation.

67. The process of claim 64, wherein said optimal pH values are within a range of 4 to 9.

68. The process of claim 64, wherein said plurality of water contaminants comprises a plurality of organic compounds.

69. The process of claim 64, wherein said plurality of organic compounds comprises a plurality of biologically active organic compounds.

70. The process of claim 69, wherein said plurality of biologically active organic compounds comprises at least one compound selected from the group consisting of a pharmaceutical compound and an agrochemical.

71. The database of claim 63, wherein said photodegradation comprises ultraviolet irradiation.

72. The database of claim 71, wherein said photodegradation is direct photodegradation.

73. The database of claim 65, wherein said optimal pH values are within a range of 4 to 9.

74. The database of claim 65, wherein said plurality of water contaminants comprises a plurality of organic compounds.

75. The database of claim 68, wherein said plurality of organic compounds comprises a plurality of biologically active organic compounds.

76. The database of claim 69, wherein said plurality of biologically active organic compounds comprises at least one compound selected from the group consisting of a pharmaceutical compound and an agrochemical.
